(19) United States
(12) Patent Application Publication
(10) Pub. No.: US 2026/0328237 A1
(43) Pub. Date: Oct. 22, 2026

(54) A Joint Assembly

(71) Applicant: OCADO INNOVATION LIMITED, Hatfield, Hertfordshire (GB)

(72) Inventors: Marthin NØRBY NIELSEN, Hatfield, Hertfordshire (GB); Alfred SÖDER, Hatfield, Hertfordshire (GB); Arvid HÄLLJE, Hatfield, Hertfordshire (GB)

(73) Assignee: OCADO INNOVATION LIMITED, Hatfield, Hertfordshire (GB)

(21) Appl. No.: 19/110,535

(22) PCT Filed: Sep. 8, 2023
(86) PCT No.: PCT/EP2023/074748

§ 371 Date: Mar. 11, 2025

(30) Foreign Application Priority Data
Sep. 12, 2022 (GB) 2213302.9

(51) Int. Cl. F16B 21/07; B65G 1/04; B66C 1/66; F16B 11/00; F16B 13/14

(52) U.S. Cl. CPC F16B 21/073; B65G 1/0464; B66C 1/663; F16B 11/006; F16B 13/141

(57) ABSTRACT

A connecting block includes i) a socket configured for receiving a connecting end of a connecting element along a first axis; ii) plural fingers resiliently biased to extend inwardly in a substantially radial direction from an internal wall of the socket to conform to the connecting end within the socket, the fingers being spatially distributed around the internal wall to define a guide for guiding the connecting end towards a centre of the socket; and iii) an inlet including an inlet bore extending along a second axis from an opening external of the connecting block to an opening in the internal wall of the socket for injecting adhesive into the socket.

### FIELD OF INVENTION

The present invention relates to the field of a fitting between a connecting block and a connecting element, more specifically to the fitting between a socket of the connecting block into which the connecting element fits into and the connecting element.

### BACKGROUND

With the increased use of lightweight materials that have a high strength to weight ratio such as carbon fibre or composite materials in the fabrication of various load bearing structures or frames, there is an increasing desire to improve the bonding between the various components of the structure or frame. The fabrication of such structures or frames involves assembling a plurality of connecting elements together into a desired shape and/or size. Joining the connecting elements together involves a fitting between a connecting block or connector and the connecting element, e.g. tube or rod, and generally involves the connecting block having a socket into which the tube or rod is inserted into. To bond the tube or rod to the connecting block, it is desirable to use an adhesive or glue to fix the tube or rod to the connecting block. A layer of adhesive is applied to the external surface of a connecting end of the tube or rod prior to the connecting end of the tube or rod being inserted into the socket of the connecting block. Equally or additionally, the internal wall of the socket can be coated with a layer of adhesive and the connecting end of the tube or rod is inserted into the socket. Any excess glue or adhesive escaping from socket is subsequently wiped clean. The tube or rod and the connecting block are firmly held together in a desired position, usually in a jig, until the adhesive has cured. The duration of holding the connecting block and connecting element together is very much dependent on the curing time of the glue or adhesive.

However, the problem with this technique of joining the connecting block to the tube or rod is that there is no control over the amount of adhesive that can be applied around the connecting end of the tube or rod prior to the tube or rod being inserted into the socket of the connecting block. Such a lack of control may cause inadequate coating of the connecting end of the tube or rod with the adhesive prior to being inserted into the socket resulting in insufficient bonding between the connecting block and the connecting element. If the time taken to cure the adhesive takes too long, the adhesive has a tendency to accumulate into a pool at the bottom of the socket depending on the orientation of the socket prior to curing. In some cases, a proportion of the adhesive may escape from the socket before the adhesive has a chance to cure. This may lead to a variation in the coverage of the connecting end of the rod or tube resulting inadequate coverage of the adhesive on the connecting end of the tube or rod with the consequence of poor adhesion between the connecting block and the tube or rod. Where the frame or structure is a load bearing structure comprising multiple connecting blocks and tubes or rods assembled together such a variability in the bonding between the various components of the frame may result in weak areas in the frame structure, particularly around the region of the joints between the connecting blocks and the connecting elements that are vulnerable to breakage.

A connecting block is thus required that does not suffer from the above problems.

### SUMMARY OF THE INVENTION

The present invention has mitigated the above problem by having a connecting block comprising a socket, wherein the socket comprises features that at least partially entraps the adhesive within the socket but allows the adhesive to flow around the connecting end of the connecting element in order to bond the connecting element to the connecting block. This provides more time for the adhesive to remain in the socket prior to curing, increasing the coverage of adhesive on the connecting element, which in turn increases the bond between the connecting element and connecting block. More specifically, the present invention provides a connecting block comprising:
i) a socket for receiving a connecting end of a connecting element along a first axis, the socket having an internal wall;
ii) a plurality of fingers resiliently biased to extend inwardly in a substantially radial direction from the internal wall of the socket such that that, in use, the plurality of fingers conform to the connecting end of the connecting element when the connecting end of the element is received within the socket, the plurality of fingers are spatially distributed around the internal wall of the socket so as to define a guide for guiding the connecting end of the connecting element towards the centre of the socket, iii) an inlet comprising an inlet bore extending along a second axis from an opening external of the connecting block to an opening in the internal wall of the socket for injecting adhesive into the socket.

For the purpose of the present invention, the connecting element can be a tube, rod, or pipe that is shaped to fit into a socket of the connecting block. The socket can be a blind hole or optionally, a through hole. In one example, the connecting block can comprise a plurality of sockets, and wherein the first axis of each of the plurality of sockets form an acute or obtuse angle with respect to each other. Optionally, the angle is between 45° to 135°. Optionally, the angle is substantially 90° such that the first axis of each of the plurality of sockets are perpendicular to each other. Optionally, the first axis of each of the plurality of sockets intersect. The term “intersect” for the purpose of the present invention is construed to cover any angle between the first axes of the respective plurality of sockets.

The cross-sectional diameter of the socket is slightly oversized than the cross-sectional diameter of the connecting element so as to permit the connecting end of the connecting element to be inserted into the socket. The plurality of fingers are resiliently biased to extend in a radial direction inwardly from the internal wall of the socket not only allow the adhesive injected into the socket to at least be partially entrapped within the socket and thereby, prevent too much of the adhesive from escaping from the socket but can also allow the adhesive to flow between the plurality of resiliently biased fingers to reach areas of the socket beyond the resiliently biased fingers. The present invention further provides an inlet comprising an inlet bore extending along a second axis from an opening external of the connecting block to an opening in the internal wall of the socket for injecting adhesive into the socket. Preferably, the internal wall of the socket comprises a sidewall such that the inlet bore extends from an opening external of the connecting block to an opening in the sidewall of the socket. In order to inject adhesive into the socket from the inlet, optionally, the first axis and the second axis form an acute or an obtuse angle. For example, the angle between the first and second axes can be in the range 35° to 135°. Optionally, the first axis is substantially perpendicular to the second axis. This option provides the most direct route from the inlet into the socket. Optionally, the first axis is substantially perpendicular to the second axis. Optionally, the first axis intersects the second axis.

The plurality of fingers acts as a barrier to at least partially entrap the adhesive within the socket for a sufficient amount of time so as to prevent too much of the adhesive escaping from the socket prior to curing. To allow the plurality of fingers to conform to the connecting end of the connecting element, optionally, the plurality of fingers are spaced apart around the internal wall of the socket. This allows one or more of the fingers to deform when the connecting end of the connecting element is inserted into the socket. The spacing between the plurality of fingers controls the level of entrapment of adhesive within the socket. Optionally, the spacing between adjacent fingers. is in the range 0.1 mm to 1 mm. The separation between the fingers is dependent on the viscosity of the adhesive. For a relatively high viscous adhesive, preferably the separation can be larger than for a relatively lower viscous adhesive. The separation between the plurality of fingers can be tailored to the viscosity of adhesive in order to control the amount of adhesive that can be entrapped within the socket prior to curing.

To maximise the level of coverage on the connecting end of the connecting element with adhesive, it is necessary that the build-up of any air upstream of the adhesive is sufficiently vented before the adhesive cures otherwise air entrapped within the socket or ahead of the adhesive will prevent an adequate supply of adhesive being injected into the socket. Not only should the plurality of fingers be able to vent air upstream of the adhesive, the plurality of fingers should at least entrap the adhesive within the socket for a sufficient amount of time so as to prevent too much of the adhesive escaping from the socket prior to curing. In the case where each of the plurality of fingers are discrete fingers each having an elongated shape, the spacing between adjacent fingers may be too small to permit the passage of air between the fingers. The spacing or gap between the fingers can close when the connecting end of a connecting element such as a tube or rod is inserted into the socket to the extent that air can potentially be entrapped within the socket. This removes the ability of the adhesive to adequately cover the connecting end of the connecting element when injected into the inlet of the socket. To provide a passageway for venting of air but yet control the flow of adhesive around the connecting end of the connecting element, optionally, the plurality of fingers comprise a plurality of fins arranged so that each of the plurality of fins at least partially overlaps an adjacent fin. The at least partially overlapping fins provide a passageway for venting of air but yet be able to control the flow of glue around the connecting end of the connecting element. As the plurality of fins are discrete fins, the spacing between adjacent fins at the root or foot of the fins connected to the internal wall of the socket is such that when the fins close on one another and about the connecting end of the connecting element a passageway between adjacent fins at the root of the fins remains open. For the purpose of the present invention, the plurality of fins close when adjacent fins are in contact. Since the plurality of fins are arranged so that adjacent fins at least partially overlaps, the plurality of fins close when at least a portion of the overlapping regions of the fins contact. The passageway is large enough to permit venting of air but provides sufficient resistance to ensure that the adhesive fills the spacing between the connecting end of the connecting element and the internal wall of the socket. An example of a shape of the plurality fins that can be arranged so that each of the plurality of fins at least partially overlaps an adjacent fin is a blade. The blade can be square shaped or triangular shaped. In the case where the blades are triangular shaped, the plurality fins are arranged in a turbo fan arrangement.

Other characteristics of the present invention is that the plurality of fingers are spatially distributed around the internal wall of the socket so as to define a guide for guiding the connecting end of the connecting element towards the centre of the socket. Once guided by the plurality of fingers, the resiliency of the plurality of fingers allows the connecting element to be repositioned within the socket. In all cases, the longitudinal axis of the connecting element defined by the first axis form an acute or obtuse angle with the second axis of the inlet bore. When the connecting element is guided along the first axis of the socket, the second axis of the inlet is substantially perpendicular to the first axis. Optionally, the plurality of fingers are arranged around the circumferential wall or perimeter of the internal wall of the socket so as to encircle the connecting end of the connecting element when the connecting end of the connecting element is inserted into the socket. Preferably, the plurality of fingers extend from the internal wall of the socket to form an opening that is concentric with the opening or mouth of the socket so as to enable the connecting end of the connecting element to be guided towards the centre of the socket. Optionally, each of the plurality of fingers is inclined with the internal wall of the socket at an angle in the range 5° to 90°. Preferably, the angle is an acute angle. The plurality of fingers are arranged circumferentially around the internal wall of the socket to form a frusto-conical shape having an opening that is concentric with the opening or mouth of the socket.

To enable the plurality of fingers to move within the socket, optionally, each of the plurality of fingers comprises a first end hingedly coupled to the internal wall of the socket by a flexible joint and a second end, wherein the second end is a free end. As stress is concentrated at the junction where the each of the plurality of fingers is hingedly coupled to the internal wall of the socket at the first end, there is a risk that one or more of the plurality of fingers may suffer from fatigue causing the one or more of the fingers to eventually break away from the internal wall of the socket. To mitigate fatigue at the junction where each of the plurality of fingers are hingedly attached to the internal wall of the socket, optionally the internal wall comprises a depression adjacent the first end of each of the plurality of fingers so as to permit each of the plurality of fingers rotate about the first end. The depression distributes the stress over a larger area rather than being concentrated at a single point on the internal wall of the socket, i.e. alleviates the stress at the junction between each of the plurality of fingers and the internal wall of the socket. In the case where the plurality of fingers comprises a plurality of fins, to enable the plurality of fins to at least partially overlap an adjacent fin, the shape of each of the plurality of fins can be such that the first end of the fin has a greater width than the second end, e.g. a triangular shape.

The second end or tip of the each of the plurality of fingers is a free end and is arranged to contact the connecting end of the connecting element when the connecting element is inserted into the socket. The second end of the plurality of fingers are arranged to form an opening within the socket that is concentric with the opening of the socket. To help guide the connecting end of the connecting element when the connecting element is inserted into the socket, optionally, the second end comprises a tapered end or has a tapered face.

The resiliency of the plurality of fingers enables movement of the connecting element within the socket when the connecting element is inserted into the socket of the connecting block. This provides a level of give or adjustment of the connecting elements relative to the connecting blocks when assembled together. To enable one or more of the plurality of fingers to deform elastically when force is applied to the one or more of the plurality of fingers, optionally, at least a portion of each of the plurality of fingers is formed from a compliant material. Examples of a compliant material include but is not limited to an elastomeric material, e.g. plastic material. Movement of the connecting element within the socket of the connecting block is particularly important when a certain level of discrepancy exists between like parts and no two connecting blocks can be reproduced to the exact same shape and/or size. This is particularly the case where the connecting blocks provide one or more functional characteristic of a build, e.g. for mounting a wheel or motor. Such discrepancies may be inherent in the manufacturing process of the connecting blocks. These include various moulding processes of the connecting block including but are not limited to additive manufacturing, injection moulding, casting or other moulding techniques known in the art. Whilst stringent quality control procedures are put in place to ensure reproducibility of the connecting blocks, there may be still be some variation in the exact shape and/or size of the connecting block. Such a discrepancy between the dimensions and/or shape of like connecting blocks is reflected when assembling the connecting blocks together by the connecting elements to form a frame or structure having a predefined tolerance in terms of dimension and/or shape. Without the ability to provide some level of give or movement of the connecting elements within the sockets of the connecting blocks, there is risk that the assembled frame or structure may not meet a predefined tolerance in terms of dimension and/or shape of the frame. Where the frame or structure form part of a larger structure or frame, i.e. a sub-frame, such a discrepancy in the shape and/or size of the connecting blocks as a result of the forming process can be amplified when the sub-frames are assembled together to form a frame. To ensure that the assembled frames or sub-frames meet a required tolerance when assembling the sub-frames together, it is necessary that during the stage of assembling the connecting blocks to the connecting elements adjustments can be made to the connecting elements relative to the connecting block when inserted within the sockets and prior to injecting adhesive into the socket. By having the plurality of fingers resiliently biased that extend in a radial direction inwardly from the internal wall of the socket allows movement of the connecting element within the socket and thereby, allowing fine adjustments to be made between the connecting element and the connecting block when a predefined tolerance in terms of shape and/or size is required.

During injection of adhesive into the socket via the inlet, the pressure of fluid, e.g. air at the head of or upstream of the adhesive, gradually builds up as the amount of adhesive increases within the socket. Without any relief, this build-up of pressure can prevent the adhesive from filling the socket. To relieve this pressure when adhesive is injected into the socket via the inlet, optionally, the connecting block further comprises an outlet comprising an outlet bore extending along a third axis from an opening in the internal wall of the socket to an outlet opening external of the connecting block for expelling fluid from the socket. Like the second axis, the third axis and the first axis form an acute or an obtuse angle. Optionally, the third axis is substantially perpendicular to the first axis or the second axis. This option is the most direct route from the socket or glue channel into the outlet. Optionally, the third axis can intersects the first axis.

The pressure of air at the head of the adhesive is dependent on the pressure applied to the adhesive when injected into the socket via the inlet. Thus, the amount of adhesive that is needed to bond the connecting element to the socket is dependent on a number of variables. These include but are not limited to:
i) The viscosity of the adhesive.
ii) The curing time of the adhesive.
iii) The applied pressure when injecting the adhesive into the socket.
iv) The build-up of pressure at the adhesive head within the socket.

In observation, low-viscosity adhesives or thin adhesive will flow more readily than high-viscosity adhesives or thick adhesives. As the outlet provides relief to this build up of pressure, adhesive exiting the outlet can provide an indication that the adhesive has sufficiently filled the socket and thus, further injection of adhesive into the socket can subsequently be stopped so as to prevent wastage of adhesive but more importantly, to prevent excess adhesive from dripping onto other areas of the frame or structure and/or components mounted to the frame or structure. As a result, the cross-sectional area of the outlet bore can have an impact on the rate at which adhesive fills the socket prior to the adhesive curing. For a given applied injection pressure, a relatively large cross-sectional area of the outlet bore allows more fluid to escape from the outlet which in turn increases the flow rate of adhesive within the socket. For the purpose of definition, the “flow rate” of adhesive is construed to mean the volumetric flow rate of fluid within the socket or glue channel, i.e. Q=V/t; where V is the volume of fluid passing through a given cross sectional area of the socket and t is the time taken to pass through the given cross sectional area of the socket and Q is the volume of fluid that is passing through the given cross-sectional area of the socket per unit time. As the connecting end of the connecting element occupies some of the volume of the socket, then the flow rate of adhesive within the socket can be taken to be the free space that extends between the internal wall of the socket and the exterior surface of the connecting element or otherwise, defined as a glue channel. For an adhesive that has a relatively long curing time, excess adhesive may be lost from the outlet as more of the adhesive would need to be injected into the socket before the adhesive has time to cure. Conversely, a relatively small cross-sectional area of the outlet bore would have an opposite effect as the smaller cross-sectional area of the outlet bore would have the effect of decreasing the flow rate of adhesive within the socket resulting in the adhesive having little time to fill the socket due to build-up of air pressure before the adhesive begins to cure. This is particularly the case where the adhesive has a relatively shorter curing time. Depending on the viscosity of the adhesive and its curing time, a compromise has to be made between the flow rate of adhesive within the socket and the cross-sectional area of the outlet bore. Examples of types of adhesives that can be used to bond the connecting element to the socket of the connecting block include but is not limited to an adhesive comprising acrylate, preferably methacrylate, more preferably methyl methacrylate.

One way to have an impact on the flow rate of adhesive within the socket is to control the cross-sectional dimension of the outlet bore. Optionally, the outlet bore comprises a first portion having a first cross sectional area and a second portion having a second cross sectional area, the second cross-sectional area being different to the first cross-sectional area such that the speed of fluid through the first portion is different to the speed of fluid through the second portion. Having differing cross-sectional areas of the outlet bore affects the speed of fluid and thus, adhesive through the outlet bore which in turn has an impact on the flow rate of adhesive within the socket as fluid is restricted from escaping from the outlet. To restrict more of the adhesive escaping from the outlet, optionally, the first cross-sectional area is smaller than the second cross sectional area such that the speed of fluid through the first portion is greater than the second portion. The smaller cross-sectional area of the first portion of the outlet bore restricts the speed of flow of adhesive within the socket and the larger cross-sectional area of the second portion of the outlet bore functions as a well due to its larger volume capacity to contain any excess adhesive flowing from the first portion. The larger cross-sectional area of the second portion helps to prevent the adhesive escaping from the opening of the outlet external of the connecting block and contaminating other areas of the frame and/or components mounted to the frame.

To increase the level of entrapment of adhesive within the socket, optionally, the plurality of fingers comprises a first set of fingers and a second set of fingers, each of the first and second set of fingers comprises the plurality of fingers according to the present invention. Optionally, the first set of fingers is spaced apart from the second set of fingers axially along a longitudinal axis of the socket. Optionally, the inlet, more specially the opening of the inlet in the internal wall of the socket, is disposed between the first and second sets of fingers. The spacing between the first and second sets of fingers define a length of the glue channel that entraps adhesive between the first and second sets of fingers. This allows different sections or portions of the connecting element to be coated with adhesive prior to the adhesive curing. Defining a length of the glue channel between the first and second sets of fingers also reduces the amount of adhesive needed to bond the connecting element to the connecting block since adhesive can be prevented from reaching areas of the connecting element will have little impact on the bond strength between the connecting element and the connecting block. In the case where the connecting element is hollow or a tube, reducing the amount of adhesive reaching the distal end of the tube limits the amount of adhesive entering the hollow portion of the tube. Not only does the first and second sets of fingers entraps the adhesive along different sections of the connecting element but also provides more support to the connecting end of the connecting element when inserted within the socket.

Whilst the plurality of fingers help to entrap the adhesive within the socket, depending on the viscosity of the adhesive, the separation between the fingers of the plurality of fingers can, optionally, enable adhesive to flow between the plurality of fingers so as to reach areas of the socket beyond the plurality of fingers. To enable the adhesive to flow past the plurality of fingers when the adhesive is injected into the socket and along the connecting end of the connecting element, optionally, the plurality of fingers are disposed between the inlet and outlet. Thus, adhesive injected into the socket via the inlet at one end of the socket is forced to flow through the plurality of fingers towards the outlet. The presence of adhesive flowing into the outlet can provide an indication that the adhesive has flowed through the plurality of fingers. Optionally, the plurality of fingers can be integrally formed within the connecting block. For example, the use of additive manufacturing in the fabrication of the connecting blocks allows complex shapes having internal structures to be fabricated as a single, integral body.

The present invention provides a joint assembly comprising:
i) a connecting block according to the present invention;
ii) a connecting element receivable within the socket of the connecting block.

Optionally, the connecting element comprises a tube or a rod.

An example of an assemblage of the connecting blocks according to the present invention bonded to connecting elements by adhesive to form a frame for supporting or mounting various components to the frame is in the fabrication of a robotic load handing device for lifting and moving one or more containers stackable in a storage and retrieval system. The storage and retrieval system comprising a grid structure comprising a plurality of grid members comprising a first set of grid members and a second set of grid members, the second set of grid members being substantially perpendicular to the first set of grid members such that the plurality of grid members are arranged in a grid pattern for guiding the movement of the robotic load handling device on the grid structure. Preferably, the present invention provides a robotic load handling device for lifting and moving one or more containers stackable in a storage and retrieval system, the storage and retrieval system comprising a grid structure comprising a plurality of grid members comprising a first set of grid members and a second set of grid members, the second set of grid members being substantially perpendicular to the first set of grid members such that the plurality of grid members are arranged in a grid pattern for guiding the movement of the load handling device on the grid structure, the robotic load handling device comprising a frame or frame structure supporting:
a) a container lifting mechanism comprising a container-gripping assembly configured to releasably grip a container, and a lifting drive mechanism configured to raise and lower the container-gripping assembly;
b) a wheel assembly comprising a first set of wheels for engaging with the first set of grid members to guide movement of the load handling device in a first direction and a second set of wheels for engaging with the second set of grid members to guide the movement of the load handling device in a second direction, wherein the second direction is transverse to the first direction;
c) a wheel positioning mechanism configured for selectively lowering or raising the first set of wheels or the second set of wheels into engagement or disengagement with the first set of grid members or the second set of grid members;
wherein the frame comprises a plurality of modular sub-frames arranged in a vertical stack, wherein at least one of the plurality of modular sub-frames comprises at least one connecting block according to the present invention and a connecting element received within the socket of the at least one connecting block.

Optionally, the frame further supports a receptacle for accommodating a power source, the receptacle having an externally accessible open top end for receiving the power source in a substantially vertical direction and comprising charging receiving elements for electrically coupling with charge providing elements of the power source to provide power to the wheel positioning mechanism and the container lifting mechanism.

Optionally, the at least one of the plurality of modular sub-frames comprises at least four connecting blocks, each of the at least four connecting blocks of each modular sub-frame is connected to two other connecting blocks by a plurality of connecting elements to form a rectangular modular sub-frame.

Optionally, each of the plurality of modular sub-frames comprises at least four connecting blocks, each of the at least four connecting blocks of each modular sub-frame is connected to two other connecting blocks by a plurality of connecting elements to form a rectangular modular sub-frame and wherein the connecting blocks of vertically adjacent modular sub-frames are connected together by a connecting element.

A plurality of the rectangular modular sub-frames are thus connectable to one another in a vertical stack by one or more vertical connecting elements to form a frame or frame structure. The different functions of the load handling device such as the container lifting mechanism, the wheel assembly, the wheel positioning mechanism, and/or the electrical components are supported by the frame structure. The term “supported” is construed broadly to include being physically being supported by the frame structure, e.g. mounted to the frame structure, and/or integrally formed with the frame structure. Optionally, the at least one connecting block comprises at least a portion of the container lifting mechanism, and/or the wheel assembly, and/or the wheel positioning mechanism, and/or the electrical components. Optionally, the at least a portion of the container lifting mechanism, and/or the wheel assembly, and/or the wheel positioning mechanism, and/or the electrical components is integrally formed with at least one connecting block.

For ease of assembly of the frame or frame structure, optionally, the one or more horizontal and/or vertical connecting elements comprises a connecting rod or tube. The connecting rods can easily be grasped and assembled into the connecting blocks in different rotational orientations. Thus, assembly of the load handling device is easier with connecting blocks and connecting rods. The frame is a three dimensional frame structure that defines a volume for housing at least a portion of the lifting mechanism, and/or the wheel assembly, and/or the wheel positioning mechanism. The individual modular sub-frames are connectable, allowing the different functions of the load handling device to be vertically stacked.

Optionally, the frame can comprise an open frame structure where the internal operational components of the load handling device, e.g. any one of the spools for carrying the lifting tethers of the container lifting mechanism, and/or the power source and/or the control unit, are visible externally of the load handling device. The term open frame structure is construed to cover a load handing device with no external cladding such that the internal components providing the functional characteristics of the load handling device of the load handling device are visible externally.

The present invention further provides an automated storage and retrieval system, the system comprising:
a grid structure comprising a plurality of grid members comprising a first set of grid members and a second set of grid members, the second set of grid members being substantially perpendicular to the first set of grid members such that the plurality of grid members are arranged in a grid pattern for guiding the movement of one or more the load handling devices operating on the grid structure; and
at least one robotic load handling device according to the present invention operable on the grid structure.

### DESCRIPTION OF DRAWINGS

Further features and aspects of the present invention will be apparent from the following detailed description of an illustrative embodiment made with reference to the drawings, in which:

FIG. 1 is a schematic drawing showing a connecting block comprising a socket for receiving a connecting element and fingers extending radially into the socket according to the present invention.

FIG. 2 is a schematic drawing showing a cross-section of the connecting block along the line X-X shown in FIG. 1.

FIG. 3 is a schematic drawing showing a cross-sectional view of the connecting block and a connecting element inserted into the socket.

FIG. 4 is a schematic drawing of a cross-section of the connecting block and a connecting element inserted into the socket.

FIG. 5 is a schematic drawing of (a) a cross-section of the connecting block showing a plurality of sets of fingers extending radially from the internal wall of the socket and spaced apart along the longitudinal axis of the socket; (b) side-view of the cross-section of the connecting block showing the plurality of sets of fingers spaced apart along the longitudinal axis Y-Y.

FIG. 6 is a schematic drawing of a joint between the connecting block shown in FIG. 5 and a connecting element engaging with the plurality of fingers when inserted into the socket of the connecting block.

FIG. 7 are schematic drawings showing the different orientations of the connecting elements within the connecting blocks depending on the cross-sectional shape of the socket and orientation of the connecting element within the socket to provide (a) angularity; (b) eccentricity; (c) ovality; and (d) combination of angularity and ovality.

FIG. 8 is a schematic drawing of a frontal side view of the connecting block showing the plurality of radially extending fingers and inlet and outlet bores extending into the socket.

FIG. 9 is a schematic drawing of a cross-section of the cross-sectional profile of the outlet bore shown in FIG. 8.

FIGS. 9b and 9c are schematic drawings of a cross-section of the connecting block showing a plurality of a second type of sets of fingers/fins extending radially from the internal wall of the socket and spaced apart along the longitudinal axis, X-X, of the socket.

FIG. 9d is a schematic drawing of a frontal side view of the connecting block of FIGS. 9b and 9c showing the plurality of radially extending fingers and inlet bore extending into the socket.

FIG. 9e is a cross-section view of the connecting block shown in FIGS. 9b to 9d with a connecting element inserted into the socket of the connecting block along the longitudinal axis X-X of the socket.

FIG. 10 is a schematic diagram of a grid framework structure according to a known system. FIG. 11 is a schematic diagram of a top down view showing a stack of bins arranged within the framework structure of FIG. 1.

FIG. 12 is a schematic diagram of a known storage and retrieval system of a load handling device operating on the grid framework structure.

FIG. 13 is a schematic perspective view of the load handling device showing the lifting device gripping a container from above.

FIG. 14 are schematic perspective cut away views of the load handling device of FIG. 11 showing (a) a container accommodated within the container receiving space of the load handling device and (b) the container receiving space of the load handling device.

FIG. 15 is a perspective view of a grabber device for engaging with a storage container according to the present invention.

FIG. 16a is a schematic drawing of the load handling device according to an embodiment of the present invention.

FIG. 16b is a schematic drawing of the load handling device showing the lowering of a power source into the receptacle according to the embodiment of the present invention.

FIG. 17 are schematic drawings of (a) the different modular sections of the load handling device shown in FIG. 16; and (b) an analogy of the different modular sections as separate rectangular frames formed by four connecting blocks.

FIG. 18 are schematic drawings of (a) an assembly of the modular sections shown in FIG. 17(a) to form an open frame structure of the load handling device; and (b) a simplified version of an assembly of the rectangular frames of the modular sections shown in FIG. 17(b) to form the open frame structure of the load handling device.

FIG. 19 is a schematic drawing showing the assembly of the connecting blocks to form a rectangular frame, the rectangular frame being braced to represent the middle halo of the open frame structure.

FIG. 20 is a schematic drawing of one face of the frame showing the connections between the first, second and third modular sections.

FIG. 21 is a schematic drawing of a connecting block forming a corner bracket of the second or middle modular section.

FIG. 22 is a schematic drawing of a connecting block forming a corner bracket of the first or bottom modular section comprising the wheel mounts.

FIG. 23 is a schematic drawing of one face of the frame showing the connections between the first, second and third modular sections.

FIG. 24 is a schematic drawing of a top view of an assembly of connecting blocks and connecting elements in a jig to provide a portion of the frame of the load handling device.

FIG. 25 is a schematic drawing of a side view of the assembly of connecting blocks and connecting elements in a jig to provide a portion of the frame of the load handling device

### DETAILED DESCRIPTION

Frames or similar structures are used in various applications and are distinguished from shell type structures or solid structures by the purpose of their design. Whereas shell structures use exterior strength to retain their shape when bearing a load on the inside, frame structures are designed to bear both external and/or internal loads. The advantage of frame structures over solid structures is that they can be constructed from lightweight materials. Where the frame forms part of a build comprising various functional components for the operation of the build, it is necessary that the frames are load bearing for supporting the various functional components of the build. Not only should the frame be load bearing but be sufficiently rigid to ensure that the dimensional tolerances of the frame does not change under an applied external force. Examples of builds that require the use of the frames that are both load bearing and rigid include but are not limited to a bicycle frame, and various other vehicle frames etc.

Typically, the frame or structure is constructed from separate load bearing elements that are assembled together. Various fasteners and/or adhesives can be used to join the separate load bearing elements together. The physical characteristics of the load bearing elements such as flexural rigidity depends largely on the application of the build. An example of the construction of a build comprising the frame according to the present invention is the construction of a robotic load handling device for lifting and moving one or more containers stackable in a storage and retrieval system. The storage and retrieval system typically comprises a grid structure comprising a plurality of grid members comprising a first set of grid members and a second set of grid members, the second set of grid members being substantially perpendicular to the first set of grid members such that the plurality of grid members are arranged in a grid pattern for guiding the movement of the load handling device on the grid structure. Further detail of the storage and retrieval system is discussed below.

Connecting blocks are used to join the load bearing connecting elements together in the construction of the frame. The connecting elements can be any straight connecting element including but are limited to a rod, tube or pipe and can comprise a plastic material, metal material and/or ceramic material and/or a composite material. Example of a composite material that possess the necessary physical characteristics of lightweight, high stiffness, high tensile strength and high strength to weight ratio is carbon fibre in a polymer matrix. Various techniques can be used to secure the connecting blocks to the connecting elements. These include the use of an adhesive or glue, fasteners or welding or a combination of any one of these securing methods. The use of an adhesive to secure the connecting block to the connecting element appears to be the most efficient and cost effective way to assemble the frame together. Whilst various commercially available adhesives have the required bonding strength to secure the connecting element to the connecting block, the ability of the adhesive to provide a secure connection between the connection block and the connecting element is largely dependent on the surface contact area of the adhesive between the connecting block and the connecting element. The larger the contact surface area of the adhesive between the connecting block and the connecting element, the greater the bond strength as more of the adhesive is able to contribute to the bond strength between the connecting block and the connecting element.

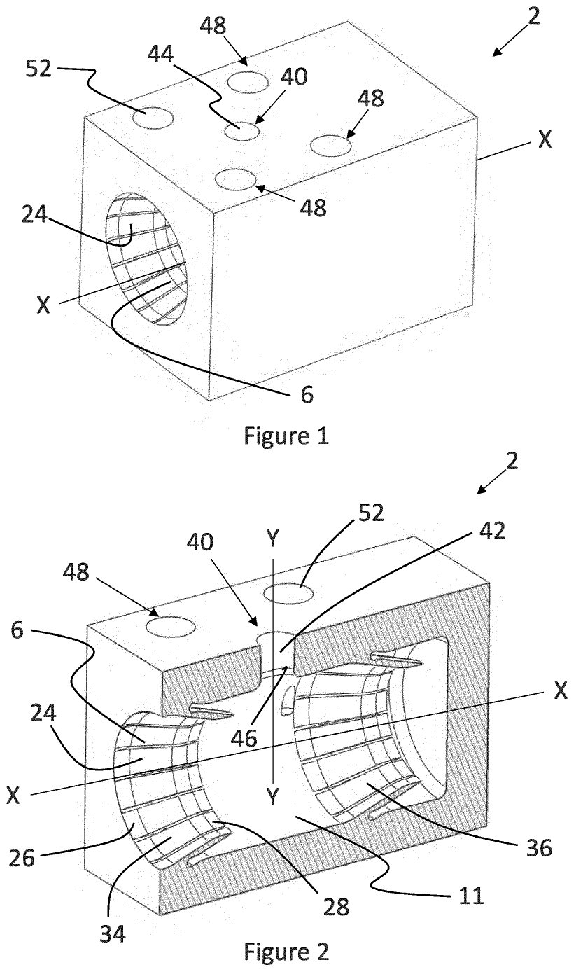

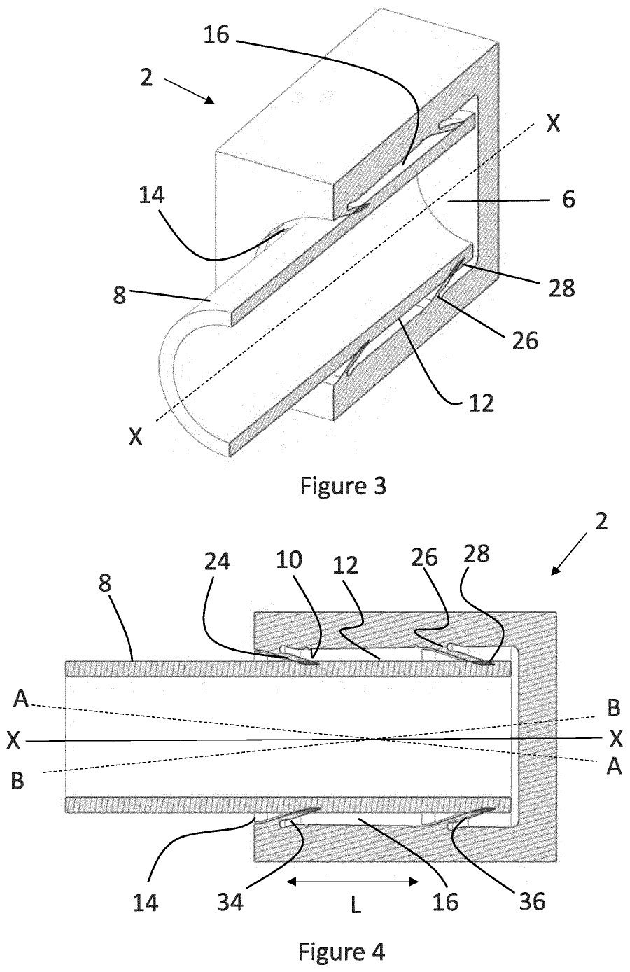

A schematic drawing of a connecting block 2 for joining connecting elements together according to the present invention is shown in FIG. 1. The connecting block 2 comprises a body 4 comprising a socket or opening 6 for inserting a connecting element 8 into the connecting block 2 (see FIG. 3). In the case where the connecting element is a rod, the bond strength between the rod and the socket having an internal wall 10 largely depends on the spread of adhesive along the connecting end 12 of the rod. For the purpose of the present invention, the connecting end of the connecting element represents the length of the connecting element that is inserted into the socket of the connecting block. Simply coating one end of the connecting element with adhesive and inserting the connecting element into the socket 6 of the connecting block 2 suffers from the problem that excess adhesive may be pushed out of the entrance or mouth 14 of the socket 6, particularly in the case where the socket is a blind hole leaving an accumulation of adhesive at the entrance of the socket. This is both unsightly and may introduce other deformities in the assembly of the frame comprising the connecting block. Secondly, coating the connecting end 12 of the connecting element does not lend itself kindly to assembling a plurality of connecting blocks with the connecting elements prior to securing or bonding the connecting blocks to the connecting elements with an adhesive. This is particularly the case where the plurality of connecting blocks and connecting elements are assembled in a jig or fixture to ensure that the connecting blocks are correctly positioned and aligned with the connecting elements in the assembly. The problem is exacerbated when the adhesive used to secure the connecting block to the connecting element has a relatively short curing time after being applied. The problem is not just limited to the connecting blocks in the construction of the frame structure for supporting the components providing the functional characteristics of a build, the problem may exist when connecting any type of connecting block with a connecting element such as a rod.

A joint is thus required that is able to secure a connecting block with the connecting element that does not suffer from the deficiencies discussed above. For avoidance of doubt, the term “joint” covers the bond between the connecting block and the connecting element. Ideally, the adhesive, which is in the form of a fluid, is introduced into the socket after the connecting end of the connecting element is inserted into the socket of the connecting block. This allows a plurality of connecting elements to be assembled together prior to bonding or securing the connecting element to their respective connecting blocks It also permits the use of a jig or fixture to control the precision or accuracy of the alignment between the connecting elements and connecting blocks, which in turn, permits the frame to be constructed to a predetermined dimensional tolerance. In the particular embodiment of the present invention, the cross-sectional dimension of the socket or opening 6 in the connecting block is purposively made slightly larger than the cross-sectional dimension of the connecting element 8 so as to create a space or gap 16 between the exterior surface of the connecting end 12 of the connecting element 8 and the internal wall 10 of the socket when the connecting end 12 of the connecting element 8 is inserted into the socket (see FIGS. 3 and 4). This space or gap 16 is filled with adhesive when bonding the connecting element with the connecting block. In the case where the socket or opening 6 in the connecting block is cylindrical for accommodating a rod or tube as shown in the particular embodiment shown in FIGS. 3 and 4, the diameter of the socket is slightly larger than the outer diameter of the rod or tube. For the purpose of definition, the spacing 16 between the exterior surface of the connecting end of the connecting element and the internal wall of the socket is termed a “glue channel” as it is created when the connecting end 12 of the connecting element 8 is inserted into the socket 6 and provides a passage for accommodating the adhesive.

In addition to creating a space for filling with adhesive, the space or gap 16 around the exterior surface of the connecting element when inserted into the socket of the connecting block also allows the connecting end of the connecting element to be moved in different orientations within the socket or opening 6 of the connecting block. For the purpose of definition of the present invention, the different orientations of the connecting element when inserted into the socket of connecting block include any angle that is offset from the longitudinal axis of the socket. The different offset angles from the longitudinal axis, X-X, of the socket is exemplified by the dashed lines, A-A and B-B, shown in FIG. 4. Typically, the connecting element is inserted into the socket in a direction along an axis corresponding to the longitudinal axis of the socket. This is considered the default position of the connecting element within the socket. However, due to the slightly oversized internal diameter of the socket in comparison to the exterior diameter of the connecting element, the connecting element can be moved at an angle that is offset from the longitudinal axis of the socket allowing adjustments to be made to the orientation of the connecting element relative to the connecting block when assembling the frame in a jig or fixture. Without the ability to allow the connecting elements to be moved in more than one orientation relative to each other in a jig or fixture when assembling the frame or sub-frame, there is risk that the assembly may not meet the required dimensional tolerances and/or shape when constructing the frame. The adjustment of the connecting element relative to the connecting block allows the assembled frame to be adjusted to the required tolerance of size and/or shape.

Where the assembly forms part of a larger frame, e.g. sub-frame, any discrepancy in the dimension or geometry of the sub-frame manifests when assembling the larger frame. Such a discrepancy in the dimension and/or geometry of the sub-frames can have an impact on the functional characteristics of a build comprising the frame. For example, where the frame forms part of a build comprising wheels for manoeuvring the build on a surface, e.g. a vehicle, any discrepancy in the dimension and/or geometry of the sub-frames may have a detrimental impact on the alignment of the wheels mounted to the frame. In a worst case scenario misalignment of the wheels having a pair of wheels at the front and rear of the vehicle as a result of a discrepancy in dimension of one of the sub-frames may cause the movement of the vehicle to yaw or be driven in an off-lead angle. This discrepancy in the dimension and/or geometry of the assembled frame may be largely attributable to the differences in the dimensional tolerance of the connecting block and/or the connecting element. Various forming techniques can be used in the formation of the connecting blocks. These includes various moulding techniques including but are not limited to additive manufacturing (3D printing), injection moulding, casting etc. However, the reproducibility of the moulded parts is dependent on a number of factors or conditions that usually cannot be accurately controlled. These include but are not limited to the environmental conditions, e.g. temperature, the consistency of the raw materials, etc. Whilst stringent quality control measures are used to ensure the reproducibility of the moulded parts, there is still exist some discrepancy in the reproducibility of like parts which will eventually manifest in a discrepancy in one or more dimensions or geometry of the frame comprising the moulded parts.

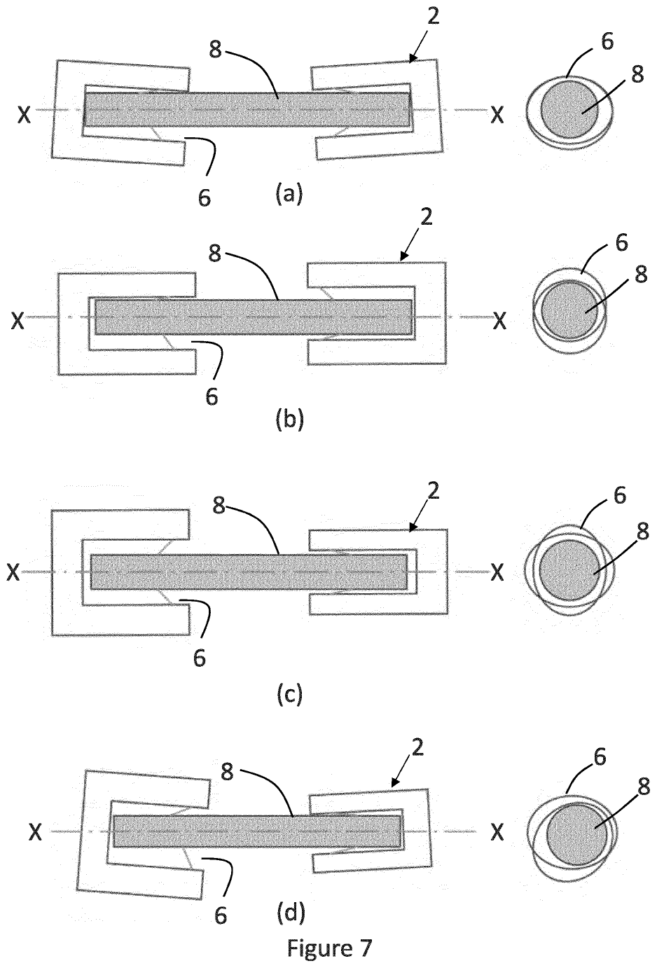

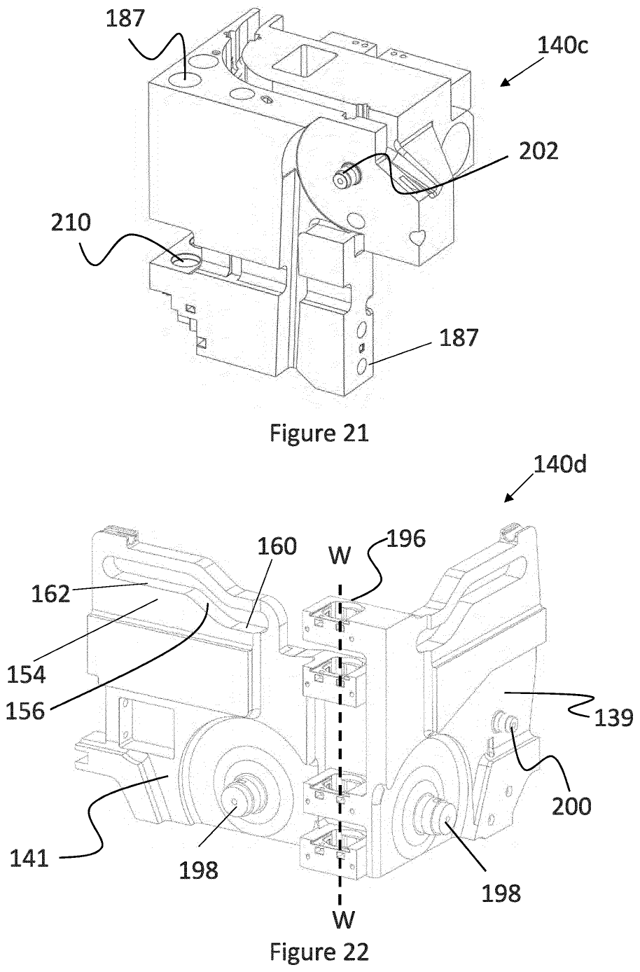

To mitigate such a discrepancy in the assembly of the frame or sub-frame, typically, a jig or fixture is used to ensure that the connecting elements are correctly aligned and/or orientated in the sub-frame or frame. The jig or fixtures controls the location of the connecting blocks and connecting elements so as to provide repeatability, accuracy and interchangeability in the manufacturing of the frame or sub-frame. An example of a jig or fixture 18 used for the assembly of a sub-frame in the building of a robotic load handling device is shown in FIGS. 21 and 22. Typically, the jig or fixture 214 comprises one or more mounting blocks 220 and/or clamps 218 comprising one or more datum points or guides that control the orientation of the connecting elements relative to the connecting blocks of the present invention, i.e. it is a work holding device that holds, supports and locates the connecting blocks and/or connecting elements during assembly. Using a jig or fixture 214 as shown in FIGS. 21 and 22 to correctly locate the connecting elements 184 with the connecting blocks 140d may involve movement of the connecting elements relative to the connecting blocks. As discussed above, to allow the orientation of the connecting element to be changed when inserted into the connecting block, the cross-sectional dimension of the socket 6 is made purposively larger than the outer cross-sectional dimension of the connecting element, i.e. in the case of a rod or tube, the diameter of the rod or tube. Movement of the connecting element within the socket allows different orientations of the connecting element relative to the connecting block depending on the datum points in the fixture or jig. Examples of the different orientations of the connecting element 8 within the socket 6 of the connecting block are shown in FIG. 7(a to d). The cross section of the assembled socket is shown adjacent the corresponding FIG. 7(a and d). The examples include but are not limited to angularity where the connecting element 8 are orientated at an angle with respect to the longitudinal axis of the socket 6 (see FIG. 7a), eccentricity where the connecting element 8 is offset from the centre of the socket 6, i.e. laterally offset from the longitudinal axis of the socket (see FIG. 7b), ovality where the cross-section of the socket adopts an oval or elliptical shape (see FIG. 7c) and a combination of any of the above (see FIG. 7d).

To initially centre the connecting end of the connecting element within the socket or opening of the connecting block, i.e. along the longitudinal axis of the socket, but yet allow the connecting end of the connecting element to be moved within the socket when adjustments are necessary during assembly in the jig or fixture, a plurality of fingers or fins 24 are disposed in the socket 6 that are resiliently biased to extend inwardly in a radial direction from the internal wall 10 of the socket as shown in FIG. 2. More specifically, the internal wall comprises a sidewall 11 and the plurality of fingers or fins 24 are resiliently biased to extend inwardly in a radial direction from the sidewall 11 of the socket 6. Each of the plurality of fingers 24 has a first end 26 anchored to the internal wall 10 of the socket 6 and a second end 28 that is free to contact the exterior surface of the connecting end 12 of the connecting element 8 when inserted into the socket (see FIG. 4). In the particular example of the present invention shown in FIGS. 1 to 6, each of the plurality of fingers are formed as discrete, elongated members radially extending from the internal wall of the socket 6. The plurality of fingers or fins are anchored to the internal wall of the socket so as to enable each of the plurality of fingers or fins to be pivotable about their respective first end 26 anchored to the internal wall of the socket. The plurality of fingers 24 are configured to guide the connecting end of the connecting element towards the centre of the socket when inserted into the socket as shown in FIG. 4 such that the connecting end of the connecting element is inserted in the socket along an axis corresponding to the longitudinal axis of the socket.

Each of the plurality of fingers or fins are configured to flex under an applied force when the connecting end of the connecting element is inserted into the socket. In the particular embodiment of the present invention, the plurality of fingers are formed from a resilient material, e.g. a plastic material that is able to deform under an applied forced and return to its current position when the applied force is removed. This is to allow one or more of the plurality of fingers or fins to conform to the external shape of the connecting end of the connecting element.

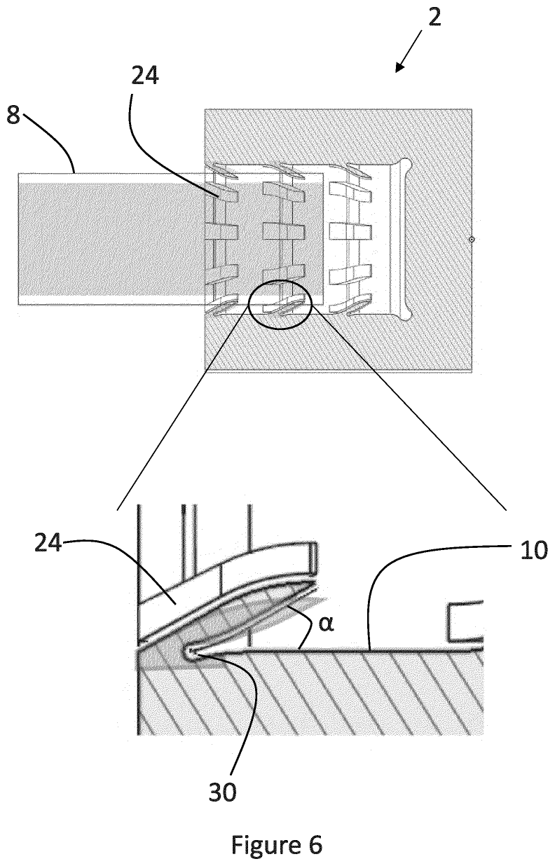

Since the connection between each of the plurality of fingers 24 and the internal wall of the socket is susceptible fatigue due to the concentration of stress around this area, there is the risk that the connection between each of the plurality of fingers and the internal wall may fail. In a worst case scenario, fatigue at the connection may result in one or more of the fingers breaking away from the internal wall of the socket. Additionally, fatigue at the junction between each of the plurality of fingers and the internal wall of the socket limits the range of movement of the plurality of fingers. To mitigate this fatigue, the internal wall 10 of the socket 6 comprises a depression 30 at the junction between each of the plurality of fingers and the internal wall of the socket to enable each of the plurality of fingers to pivot about their respective anchoring point (see FIG. 6). The depression 30 acts to distribute the stress around the junction rather than concentrate the stress at a single point.

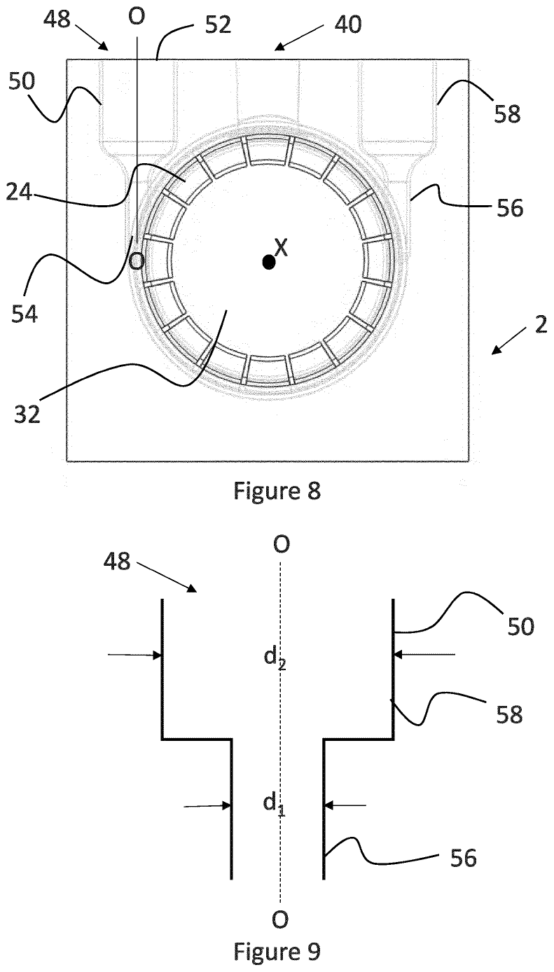

As shown in FIGS. 3 and 4, the plurality of fingers 24 are arranged around the inner circumferential wall 10 of the socket and extend radially inwardly towards the centre of the socket. Each of the plurality of fingers forms an acute angle a with the internal wall of the socket (see FIG. 6) such that the plurality of fingers 24 adapt a frusto-conical shape within the socket having an opening 32 that is substantially concentric with the opening 14 of the socket 6 (see FIGS. 2 and 8). In other words, the plurality of fingers are arranged circumferentially around the internal wall of the socket such that their respective free or second ends form an opening 32 that is concentric with the opening or mouth of the socket. Thus, for the purpose of definition, the term “radial” in respect to the plurality fingers covers any angle a less than 90° inclusive of 90° that each of the plurality of fingers makes with the internal wall of the socket. In the particular embodiment of the present invention shown in FIG. 6, the each of the plurality of fingers or fins is at an acute angle with respect to the internal wall of the socket. As shown in FIG. 2, the plurality of fingers 24 are arranged around the inner circumferential wall of the socket so as to define an opening 32 for receiving the connecting end of the connecting element that is concentric with the opening 14 of the socket. The plurality of fingers 24 are angled to the internal wall of the socket such that the opening 32 defined by the second, free end of the plurality of fingers has a diameter less than the cross-sectional diameter of the connecting element. As a result, the free, second end 28 of each of the plurality of fingers or fins engages or contacts the exterior surface of the connecting end 12 of the connecting element when the connecting end of the connecting element is inserted into the socket (see FIGS. 3 and 4). The resilient properties of the plurality of fingers 24 allows the plurality of fingers to conform to the connecting end 12 of the connecting element 8 by flexing about its connection with the internal wall of the socket as shown in FIGS. 3 and 4. The plurality of fingers help to guide the connecting end of the connecting element towards the centre of the socket when the connecting end of the connecting element is inserted into the socket 6 along the longitudinal axis of the socket. To assist with guiding the connecting end of the connecting element into the socket, the second end 28 of each of the plurality of fingers is tapered or has an inclined surface that is configured to cooperate with the exterior surface of the connecting end of the connecting element as shown in FIG. 2.

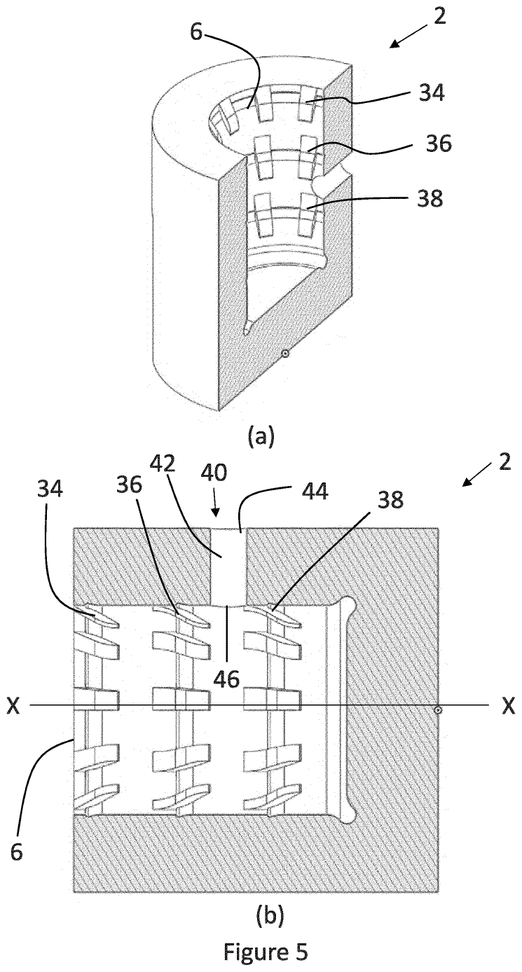

To provide further support to the connecting end of the connecting element when inserted into the socket, one or more sets of fingers can be disposed within the socket, each of the one or more sets of fingers comprising a plurality of the fingers discussed above. In the particular embodiment shown in FIG. 2, first 34 and second 36 sets of fingers are shown spaced apart along the longitudinal axis of the socket. The first 34 and second 36 sets of fingers guides the connecting end of the connecting element as it is inserted into the socket such that an axis X-X extending longitudinally along the centre of the connecting element is substantially co-axial with an axis extending longitudinally along the centre of the socket (see FIGS. 3 and 4). This is considered the default or natural position of the connecting end of the connecting element when inserted within the socket 6. The resiliency of the plurality of fingers 24 allows the connecting end of the connecting element to be moved within the socket. However, the present invention is limited to having first and second sets of fingers as shown in FIG. 2 and can be any number of sets of fingers. The number of sets of fingers largely depends on the depth of the socket and the support that is necessary when the connecting end of the connecting element is inserted into the socket. A relatively greater depth of socket may require a plurality of sets of fingers spaced apart longitudinally along the length of the socket to stabilise the connecting end of the connecting element within the socket than a relatively shorter depth of socket. For example, FIG. 5(a and b) is an illustration of a connecting block 2 comprising three sets of fingers 34, 36, 38 that are spaced apart along the longitudinal axis X-X of the socket, each of the sets of fingers are arranged around the internal wall of the socket to provide an opening that is substantially concentric with the opening of the socket.

Once the connecting elements have been correctly located within the socket of their respective connecting block guided by the jig or fixture, adhesive is used to secure the position and/or orientation of the connecting element to its respective connecting block. To apply adhesive to the connecting end of the connecting element once the connecting element is inserted into the connecting block, the adhesive is injected into the socket from an opening external of the connecting block. In the particular embodiment of the present invention, the connecting block comprises an inlet or injection point 40 comprising an inlet bore 42 extending along a second axis, Y-Y, from the opening 44 external of the connecting block to an opening 46 in the internal wall of the socket for injecting adhesive into the socket (see FIGS. 1, 2 and 5). The first axis being the axis along the longitudinal axis of the socket. The second axis or inlet axis Y-Y is angled such that the second axis forms an acute or obtuse angle with the first axis corresponding to the longitudinal axis of the socket, (see FIG. 2). The angle of the second axis with the first axis can be at any angle so as enable adhesive to be injected into the socket. Optionally, the angle of the first and second axis can be in the range 35° to 135°. In the particular example of the present invention shown in FIG. 2, the second axis, Y-Y, is substantially perpendicular to the first axis, X-X, corresponding to an angle of 90°. This allows adhesive to be injected directly into the socket 6 (along the glue channel) once the connecting end of the connecting element has been inserted into the socket. In the particular embodiment of the present invention shown in FIG. 2, the first axis intersects the second axis. However, the present invention is not limited to the first axis intersecting the second axis.

Injecting adhesive into the socket of the connecting block raises another problem of the need to retain the adhesive within the socket prior to the adhesive curing. Once cured, there is limited opportunity to make any adjustments to the orientation of the connecting elements relative to its respective connecting block. Without any retention mechanism once the adhesive is injected into the socket, there is the risk that some of the adhesive may flow out of the socket via the opening or mouth of 14 the socket reducing the coverage of the adhesive on the connecting end of the connecting element within the socket. This is in return may have an impact on the bond strength between the connecting element and the connecting block. Thus, in addition to guiding the connecting end of the connecting element towards the centre of the socket, i.e. along the longitudinal axis of the socket, the plurality of radially extending fingers 24 arranged around the inner circumferential wall 10 of the socket cooperates with the connecting end of the connecting element to provide some resistance or a barrier for preventing the adhesive flowing out of the socket. This resistance can be determined by the level of entrapment of adhesive within the socket. In the particular embodiment of the present invention shown in FIGS. 2 and 5, the spacing or separation between the individual fingers can be used to control the amount of adhesive that can be entrapped within the socket. A relatively large separation between adjacent fingers as shown in FIG. 5(a and b) provides minimal entrapment of adhesive as adhesive is able to flow between the separated fingers and a relatively small separation between adjacent fingers provides maximum entrapment as adhesive is largely prevented from flowing between the separated fingers. The separation or gap between adjacent fingers is also dependent on the viscosity of the adhesive. For a relatively high viscous or thick adhesive, a large separation between adjacent fingers may be sufficient to entrap a substantial proportion of the adhesive within the socket than a relatively low viscous or thin adhesive. Depending on the viscosity range of the adhesive, the separation or gap between adjacent fingers can be in the range 0.1 mm to 1 mm, optionally in the range 0.1 mm to 0.5 mm.

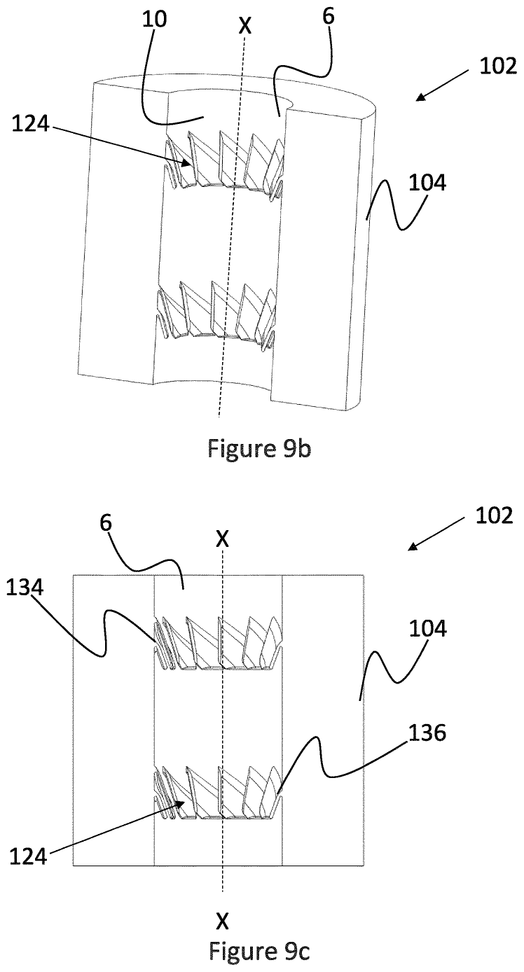

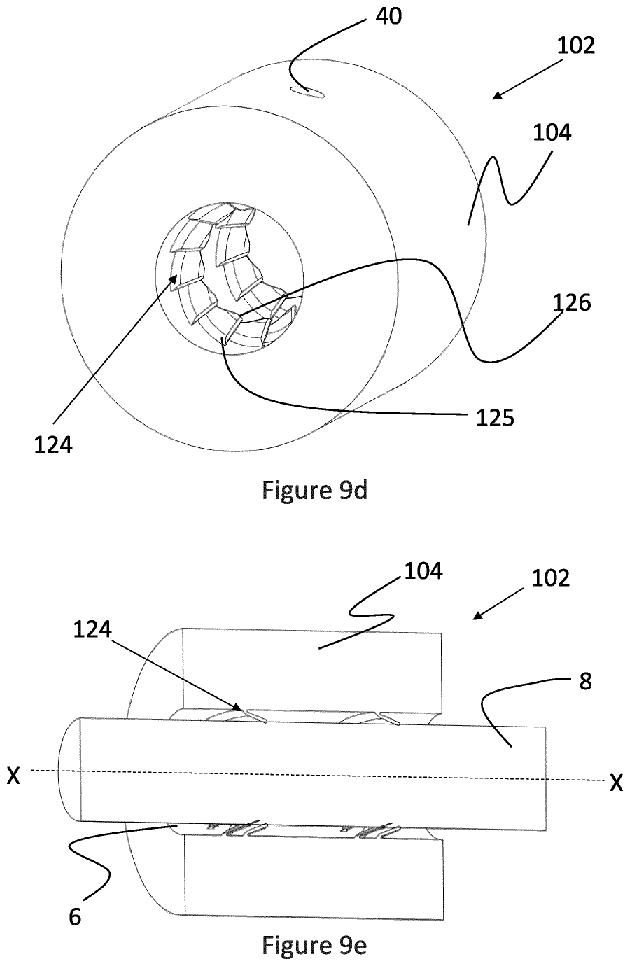

Whilst the particular example of the present invention discussed above describe the plurality of fingers as discrete, elongated members, the present invention is not limited to the plurality of fingers being formed as elongated members. For example, the plurality of fingers can be arranged so that adjacent fingers at least partially overlap each other as shown in the particular example shown in FIG. 9(b to e). Like the plurality of fingers discussed with reference to FIGS. 1 to 5, the plurality of fingers in the second example shown in FIG. 9(b to e) are spaced apart to enable fluid such as air to pass between the plurality of fingers but yet provides a barrier to at least prevent the adhesive from flowing beyond the plurality of fingers and thereby, help to entrap the adhesive within the socket. The problem with the plurality of fingers being formed as elongated members is that there is a tendency that the spacing between adjacent fingers being too small to allow the passage of air in the space between adjacent fingers. This is particularly exacerbated when the connecting end of the connecting element is inserted into the socket of the connecting block. As the plurality of fingers are compliant, the spacing between adjacent fingers has a tendency to largely close when the plurality of fingers conform to the exterior shape of the connecting element when inserted into the socket. In a worst case scenario, the pressure of air upstream of the adhesive will build up preventing the adhesive reaching the plurality of fingers and adequately covering the connecting end of the connecting element with adhesive, i.e. filling the glue channel.

In the second example of the connecting block 102, the plurality of the plurality fingers 124 shown in FIG. 9(b to e) are arranged circumferentially around the internal wall 10 of the socket 6 so that adjacent fingers 124 at least partially overlap. The partially overlapping region of the plurality of fingers 124 enable adjacent fingers to contact each other when the connecting end of a connecting element is inserted into the socket (see FIG. 9e) but yet still provides a passageway for the venting of air through the plurality of fingers. In other words, the at least partially overlapping fingers 124 prevent the spacing between adjacent fingers from closing entirely. To maximise the extent to which adjacent fingers overlap, the first end or connecting end 125 of each of the plurality of fingers is anchored to a greater proportion of the internal wall 10 of the socket in comparison to the elongated members shown in FIGS. 1 to 5. In the second example shown in FIG. 9(b to d), the plurality of fingers 124 are formed as discrete fins or blades that are arranged into a “turbo” blade design. Each of the plurality of fingers has a triangular shape and anchored to the internal wall of the socket such that the width of the first ‘connecting’ end 125 of the fin is greater than the second ‘free’ end 126 of the fin. When the spacing between adjacent fins or blades close, i.e. when the connecting end of a connecting element is inserted into the socket 6, the spacing between adjacent fins at the foot or first end 125 of each of the plurality of fins or blades remains open to provide a passageway for air to escape but the overlapping fins (towards the second end 126 of the fins) minimizes the flow of the more viscous adhesive to flow between the plurality of fins or blades. The venting of the air through the plurality of fins allows more of the adhesive to be injected into the socket (i.e. in the glue channel) as there is little resistance to the flow of adhesive within the glue channel as a result of the passage of air through the plurality of fins. The shape of each of the fins is not limited to having a triangular shape and any other shape is permissible in the present invention so as long adjacent fins at least partially overlap. For example, each of the plurality of fins can be square shaped.

The position of the inlet 40 relative to the plurality of fingers also has an influence on the entrapment of adhesive within the socket. Ideally, the plurality of fingers are positioned at the entrance or mouth 14 of the socket so as to maximise the entrapment of adhesive at the mouth of the socket. In the particular embodiment shown in FIG. 2, a first set of fingers 26 are disposed at the entrance or mouth of the socket and the inlet 40 is positioned deeper into the socket beyond the first set of fingers such that adhesive injected into the socket via the inlet 40 is forced to flow around the connecting end of the connecting element as this is the path of least resistance rather than flowing through the plurality of fingers, i.e. flow along the glue channel 16. As a result, there is a greater tendency for the adhesive to fill the glue channel 16 before being entrapped by the plurality of fingers and thereby, providing more effective bonding between the connecting element and the connecting block.

By virtue of the ability of the plurality fingers to at least entrap the adhesive within the socket, a plurality of sets of fingers can also be used to control the coverage of adhesive on the connecting end 12 of the connecting element 8 inserted into the socket, i.e. control the size or length of the glue channel (see FIG. 4). It may not be essential to coat the entirety of the connecting end of the connecting element to achieve a predetermined bond strength between the connecting end and the connecting block. For example, the bond strength between the connecting element and the connecting block is very much dependent on the amount of adhesive injected into the socket to which diminishing returns in terms of bond strength is reached when a predetermined amount of adhesive injected into the socket has been reached. It has surprisingly been found that little or no adhesive at the free end or distal end of the connecting end of the connecting element has little influence on the bond strength between the connecting element and the connecting block. This has the advantage of reducing the amount of adhesive necessary to bond the connecting element to the connecting block in order to provide a predetermined bond strength. Any adhesive beyond this amount results in a limited increase in bond strength or diminishing returns. In the case where the connecting elements are tubes or hollow rods, limiting that amount of adhesive that reaches the free end or distal end of the connecting element also reduces the amount of adhesive entering the hollow section of the connecting element. Considering that assembly of a frame structure requires multiple joints between numerous connecting elements and the connecting blocks, reduction in the amount of adhesive at each of the joints will have an impact on the total amount and thus, cost of adhesive used in the construction of the frame for the load handling device. This is particularly the case where specialised adhesives having specific physical characteristics are used in the construction of the frame.

In the particular embodiment of the present invention shown in FIG. 4, the second set of fingers 38 is spaced apart from the first set of fingers 36 by a length ‘L’ along the longitudinal axis of the socket such that the inlet 40 is positioned between the first and the second sets of fingers 36, 38 (see FIG. 2). The separation between the first 36 and second 38 sets of fingers defines the length ‘L’ of the glue channel which ultimately controls the bond strength (see FIG. 4). Adhesive injected into the socket via the inlet is at least entrapped between the first 36 and the second 38 sets of fingers so as to ensure that there is enough coverage of adhesive around the most crucial part of the connecting end of the connecting element between the first and second sets of fingers and little or no adhesive around the least crucial part of connecting end of the connecting element which has little or no impact on the bond strength. In the case where the socket is a blind hole having an end wall as shown in the particular embodiment of the present invention shown in FIG. 4, the second set of fingers 38 is set back from the end wall of the socket so as to limit the amount adhesive reaching the distal end of the connecting element adjacent the end wall of the socket that has limited impact on the bond strength which in turn reduces the length ‘L’ of the glue channel.

Like the first example of the connecting block described with reference to FIG. 2, the plurality of fins 124 described with reference to FIG. 9(b to e) comprises a first set of fins 134 disposed at the entrance or mouth of the socket and a second set of fins spaced apart in a direction along the longitudinal axis, X-X, of the socket. The inlet 40 for injecting adhesive into the socket is disposed between the first and the second sets of fins such that adhesive injected into the socket is entrapped in the region of the glue channel between the first and second sets of fins. Due to the ability of the at least partially overlapping fins to provide a passageway for venting of air but minimizes the flow of the more viscous through the plurality of fins, more of the adhesive is able to flow between the first and second sets of fins providing greater coverage of the adhesive on the connecting end of the connecting element.

Whilst the plurality of fingers are configured to cooperate with the connecting end of the connecting element to provide entrapment of adhesive within the socket, the separation of the fingers should permit thinner fluids such as air to pass through the plurality of fingers. When adhesive is injected into the socket via the inlet 40, the pressure of fluid, e.g. air, within the socket builds up particularly around the glue channel 16 as adhesive fills the glue channel. Without any means to relieve this pressure, the build-up of pressure at the head of the adhesive will have an impact on the amount of adhesive injected into the socket 6 and thus, a consequential impact on the filling rate of adhesive within the socket, i.e. the glue channel. To relieve this pressure, the connecting block further comprises an outlet or vent hole 48 having an outlet bore 50 extending along a third axis, O-O, from an opening 54 in the internal wall (side wall) of the socket to an outlet opening 52 external of the connecting block for expelling fluid from the socket. As with the inlet, the third axis, O-O, is orientated so as to form an angle with the first axis, X-X, corresponding the longitudinal axis of the socket. The angle the third axis makes with the first axis can be at any angle so as to vent fluid from the socket. Optionally, the angle the first make with the third axis can be in the range 35° to 135°. In the particular example of the present invention shown in FIG. 8, the third axis, O-O, is substantially perpendicular to the first axis, X-X, corresponding to an angle of 90°. This allows air entrapped within the socket to be vented directly from the socket 6 (along the glue channel) once adhesive is injected into the glue channel. Whilst not shown in FIG. 8, the third axis can intersect the first axis of the socket.

The outlet or vent hole 48 also provides an indication of the status of fill of the adhesive within the socket. Consequential, the vent hole provides an indication of the capacity of the socket, more particularly, the glue channel, to hold adhesive. Thus, adhesive emerging from the vent hole or outlet 48 provides an indication that adhesive has sufficiently filled the glue channel with adhesive. One or more vent holes or outlets 48 are strategically placed around the connecting block and in fluid communication with different portions of the socket to vent air entrapped within the socket and to provide an indication of the status of fill of the different portions of the socket 6 or glue channel 16. In the particular embodiment of the present invention shown in FIG. 1, four vent holes 48 are shown disposed between the first and second sets of fingers, each of the four vent holes 48 providing an indication of the fill rate of at least portion of the socket or glue channel with adhesive. The pattern of vent holes is dependent on the fill rate of the adhesive in the different portions of the glue channel. The four vent holes 48 are shown arranged in a square or rectangular pattern with one at each corner and the inlet opening 40 arranged in the middle, i.e. quincunx pattern. Adhesive emerging from the vent holes 48 largely depends on the fill capacity of the socket or glue channel 16 and the manner in which the adhesive fills the socket or glue channel. Adhesive will initially emerge from the vent hole in fluid communication with the corresponding portion of the socket or glue channel that fill first and so on as the other portions of the socket or glue channel fills with adhesive. The vent holes are also shown located in the same wall of the connecting block as the inlet 40. This is to ensure that the adhesive injected into the socket via the inlet adequately fills the glue channel 16.

Another important consideration is the rate of flow of adhesive within the socket or glue channel once it is injected into the socket. For the purpose of definition, the “flow rate” of adhesive is construed to mean the volumetric flow rate of fluid within the socket or glue channel, i.e. Q=V/t; where V is the volume of fluid passing through a given cross sectional area of the glue channel and t is the time taken to pass through the given cross sectional area of the glue channel and Q is the volume of fluid that is passing through the given cross-sectional area of the glue channel per unit time. The flow rate of adhesive through the glue channel is largely controlled by the pressure applied to the adhesive when injected into the socket via the inlet 40 but also on the rate at which fluid, e.g. air, entrapped within the glue channel is vented from the outlet 48. For a given injection rate of adhesive into the socket, a greater restriction of fluid able to be vented from the vent hole 48, the lower the rate at which adhesive can flow within the socket or glue channel as the flow of adhesive along the glue channel is impeded by the build-up of pressure within the socket or glue channel. Conversely, a smaller restriction of fluid able to be vented from the vent hole, the higher the rate at which adhesive can flow within the socket or glue channel as there is little impedance to the flow of adhesive in the socket or along the glue channel. The cross-sectional dimension (e.g. diameter) of the outlet bore 50 may have an influence on the rate at which adhesive flows in the socket or along the glue socket. By controlling the cross-section dimension of the outlet bore 50, the rate of flow of adhesive within the socket or along the socket can be controlled.

However, whilst a smaller cross-sectional dimension of the outlet bore 50 restricts the flow of fluid through the outlet or vent 48, the outlet bore has a tendency to fill quickly with adhesive once at least a portion of the glue channel fills with adhesive due to the smaller volume capacity of the outlet bore. In a worst case scenario, the smaller volume capacity of the outlet bore has a tendency to cause adhesive to overfill the outlet bore 50. Without any means to capture this overfill, the adhesive may drip onto other areas of the frame. To mitigate this problem, the cross-sectional dimension of the outlet bore 50 varies to change the volume and thus, the speed of the fluid within the outlet bore. For example, the outlet bore can comprise a first portion 56 having a first cross-sectional dimension and a second portion 58 having a second cross-sectional dimension, the second cross-sectional dimension being different to the first cross-sectional dimension such that for a given applied pressure of adhesive, the speed of fluid through the first portion 56 is different to the second portion 58. The advantage of the vent hole or outlet where the outlet bore has a varying cross-sectional dimension is that the first portion of the outlet bore can be used to constrict the flow of fluid through the vent hole allowing adhesive to adequately fill the glue channel and the second portion of the outlet bore can capture any overfills of adhesive from the first portion of the vent hole due to its larger volume capacity. This can be explained by the simple fluid flow rate equation below (equation 1) in conjunction with a cross-section of the outlet bore shown in FIG. 9. Taking the fluid to be a liquid which is incompressible, then the volumetric flow rate of fluid through the first portion 56 of the outlet bore can be taken to be equal to the volumetric flow rate of fluid through the second portion 58 of the outlet bore.

Q₁=Q₂ (1)

where Q₁ is the volumetric flow rate of liquid fluid through the first portion of the outlet bore; and Q₂ is the volumetric flow rate of liquid fluid through the second portion of the outlet bore. Hypothetically, this could be equated to:

A₁v₁=A₂v₂ (2)
where A₁ is the cross-sectional area of fluid in the first portion of the outlet bore;
A₂ is the cross-sectional area of fluid in the second portion of the outlet bore;
v₁ is the speed of fluid in the first portion of the outlet bore; and
v₂ is the speed of fluid in the second portion of the outlet bore.

In the particular embodiment of the present invention shown in FIGS. 8 and 9, the first portion 56 of the outlet bore extending from the opening 54 in the internal wall (sidewall) of the socket has a smaller cross-sectional dimension d₁ than the second portion 56 of the outlet bore 50 having a larger cross-sectional dimension of d₂ leading up to the opening 52 external of the connecting block, i.e. the outlet bore adopts a funnel-like shape. The smaller cross sectional dimension d₁ of the first portion 56 of the outlet bore restricts the speed of fluid through the first portion of the outlet bore and consequently, have an impact on the filling rate of adhesive in the glue channel allowing more time for the adhesive to adequately fill the glue channel. The larger cross sectional dimension d₂ of the second portion 58 of the outlet bore 50 captures any overfills from the first portion 56 and thereby, providing enough delay to prevent the adhesive from overfilling the second portion 58 of the outlet bore and escaping the outlet. Adhesive emerging in the second portion 58 of the outlet bore provides an indication that the adhesive has substantially filled the glue channel at which case further injection of adhesive into the inlet 40 can be stopped.

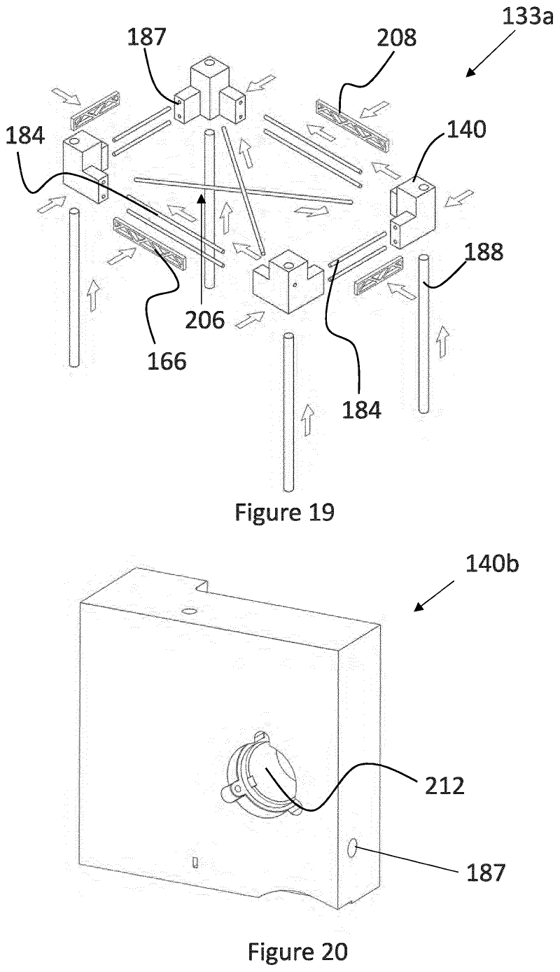

The socket in the connecting block is not just limited to being a blind hole as shown in FIGS. 1 to 7 but can be a through hole, in which case, at least one of the sets of fingers are disposed within the through hole. This could be a single set of plurality of fingers or a plurality of sets of fingers as exemplified in the socket shown in FIG. 2 or FIG. 5(a and b). Moreover, the connecting block according to the present invention is not just limited to a single socket but can comprise a plurality of sockets, each of the plurality of sockets comprising at least one set of fingers disposed within the socket for guiding the connecting end of the connecting element towards the centre of their respective socket. Each of the plurality of sockets can be a blind hole or a through hole or a combination of a blind hole and a through. For example, it may be necessary for the connecting block to comprise sockets that is a blind hole and a through hole as demonstrated with the connecting block shown in FIG. 19. In FIG. 19, the function of which will be explained later, the connecting block comprises a plurality of blind holes for connecting the connecting block to two other connecting blocks in the same horizontal plane to form a rectangular modular sub-frame and a through hole for connecting multiple rectangular modular sub-frames together in a vertical stack. The modular sub-frame can be a rectangular modular sub-frame as depicted in FIG. 19. The first axis of each of the plurality of sockets corresponding to the longitudinal axis of the socket can be arranged such that they form an acute or obtuse angle with respect to each other. This is particularly the case where the connecting block comprises a first socket and a second socket, and wherein the first socket is a blind hole and the second socket is a through hole. The angle of their respective first axes can be any angle such that the connecting elements can be separately connected to the connecting block, e.g. in the 35° to 135°. In the particular embodiment of the present invention shown in FIG. 19, the first axis of the first socket comprising the blind hole is substantially perpendicular to the first axis of the second socket comprising the through hole. Whilst it is not essential, the first axis of the first socket forming the blind hole can optionally intersect the first axis of the second socket forming the through hole (see FIG. 19). Having the first axes of respective sockets in a given connecting block intersect provides symmetry to the modular sub-frame when at least four connecting blocks are assembled together with the connecting elements.

Having the ability to adjust the orientation of one or more of the plurality of connecting elements when assembled together by the use of the connecting block according to the present invention enables various frame or frame structures to be assembled together to the required dimensional tolerance. One particular build that is very much dependent on the dimensional tolerance of its frame or frame structure is in the construction of a robotic load handling device. The construction of a robotic load handling device in the field of a storage and retrieval system will be used as an example of the construction of a frame based on the connecting blocks according to the present invention described above.

### Storage and Retrieval System

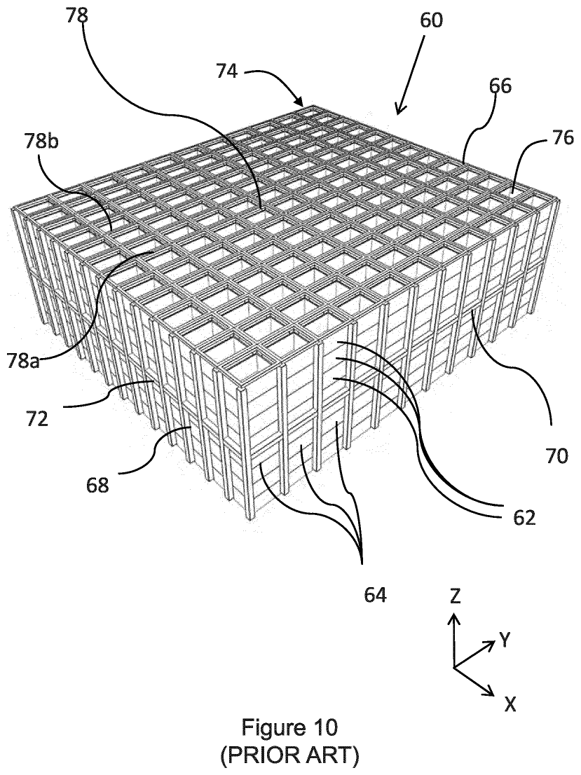

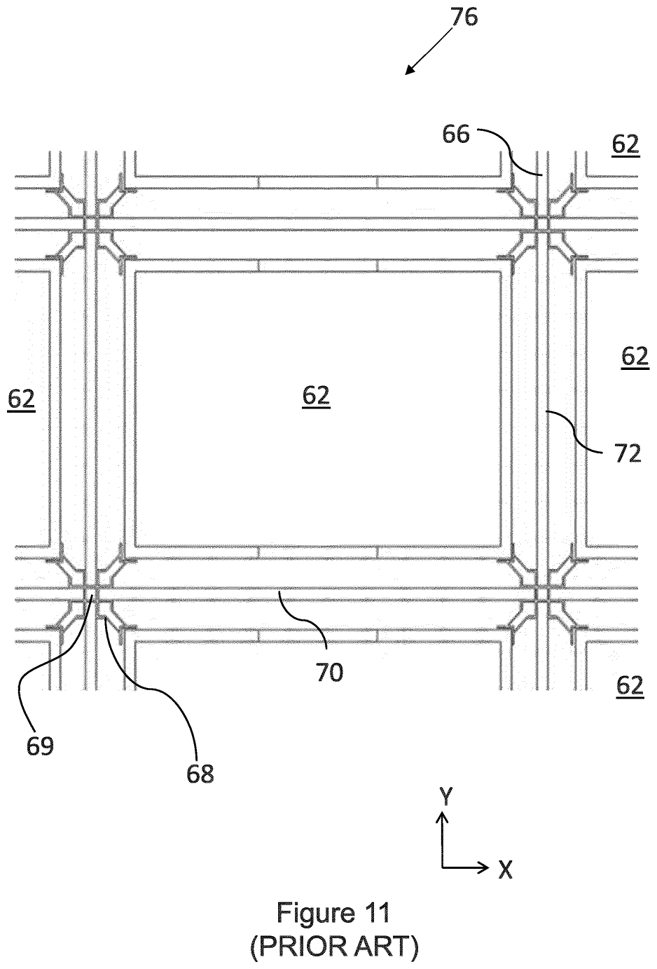

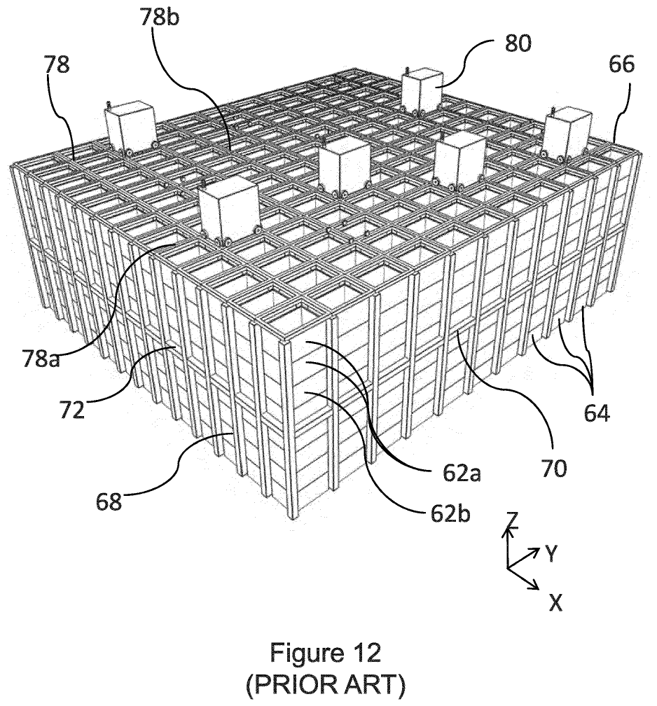

Storage and retrieval systems 60 comprising a three-dimensional storage grid framework structure 66, within which storage containers/bins are stacked on top of each other, are well known. PCT Publication No. WO2015/185628A (Ocado) describes a known storage and fulfilment or distribution system in which stacks of bins or containers are arranged within a grid framework structure. The bins or containers are accessed by robotic load handling devices remotely operative on tracks located on the top of the grid framework structure. A system of this type is illustrated schematically in FIGS. 10 to 12 of the accompanying drawings.

As shown in FIGS. 10 and 11, stackable containers, known as storage bins or containers 62, are stacked on top of one another to form stacks 64. The stacks 64 are arranged in a three dimensional grid framework structure 66 in a warehousing or manufacturing environment. The grid framework structure 66 is made up of a plurality of storage columns or grid columns. Each grid in the grid framework structure has at least one grid column for storage of a stack of containers. FIG. 10 is a schematic perspective view of the grid framework structure 66, and FIG. 11 is a top-down view showing a stack 64 of bins 62 arranged within the framework structure 66. Each bin 62 typically holds a plurality of product items (not shown), and the product items within a bin 62 may be identical, or may be of different product types depending on the application. Bins 62 may also be referred to as storage bins or containers or storage containers or totes.

In detail, the three dimensional grid framework structure 66 comprises a plurality of vertical uprights or upright members or upright columns 68 that support horizontal grid members 70, 72. A first set of parallel horizontal grid members 70 is arranged perpendicularly to a second set of parallel horizontal grid members 72 to form a grid structure or grid 74 comprising a plurality of grid cells 76. The grid cell has an opening to allow a load handling device to lift a container or storage bin through the grid cell. In the grid structure, the first set of parallel horizontal grid members 70 intersect the second set of parallel horizontal grid members at nodes 69. The grid structure can be supported by the upright members 68 at each of the nodes or at the point where the grid members intersect such that the upright members are interconnected at their tops ends by the intersecting grid members. The grid members 68, 70, 72 are typically manufactured from metal and typically welded or bolted together or a combination of both. The storage bins or containers 62 are stacked between the upright members 68 of the grid framework structure 66, so that the upright members 68 guard against horizontal movement of the stacks 64 of bins 64, and guide vertical movement of the storage bins 62.

The top level of the grid framework structure 66 includes rails or tracks 78 arranged in a grid pattern across the top of the stacks 64. Referring additionally to FIG. 3, the rails 78 support a plurality of load handling devices 80. A first set 78a of parallel rails 78 guide movement of the robotic load handling devices 80 in a first direction (for example, an X-direction) across the top of the grid framework structure 66, and a second set 78b of parallel rails 78, arranged perpendicular to the first set 78a, guide movement of the load handling devices 80 in a second direction (for example, a Y-direction), perpendicular to the first direction. In this way, the rails 78 allow movement of the robotic load handling devices 80 laterally in two dimensions in the horizontal X-Y plane, so that a load handling device 80 can be moved into position above any of the stacks 64.

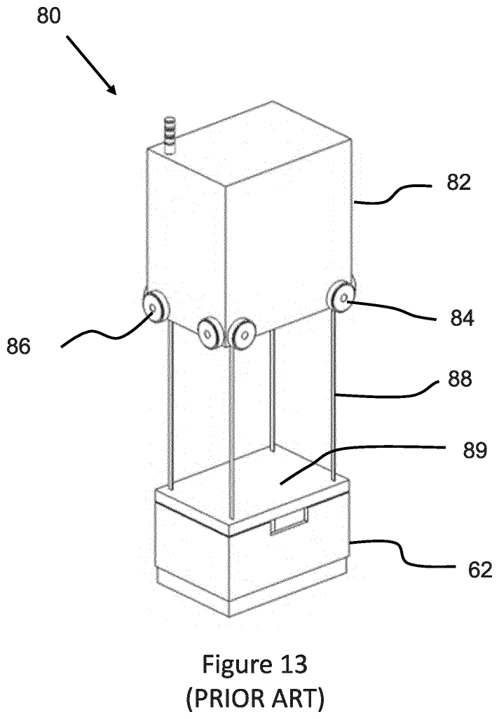

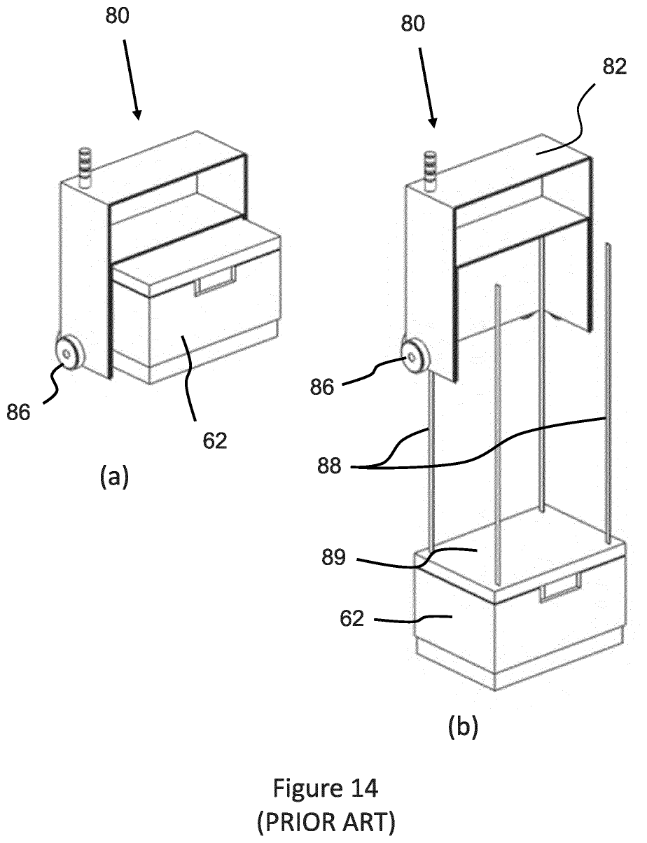

A known load handling device or robotic load handling device otherwise known as a bot 80 shown in FIGS. 13 and 14 comprising a vehicle body 82 is described in PCT Patent Publication No. WO2015/019055 (Ocado), hereby incorporated by reference, where each load handling device 80 only covers a single grid space or grid cell of the grid framework structure 66. Here, the load handling device 80 comprises a wheel assembly comprising a first set of wheels 84 consisting of a pair of wheels on the front of the vehicle body 82 and a pair of wheels 84 on the back of the vehicle 82 for engaging with the first set of rails or tracks to guide movement of the device in the first direction, and a second set of wheels 86 consisting of a pair of wheels 86 on each side of the vehicle 82 for engaging with the second set of rails or tracks to guide movement of the device in the second direction. Each of the sets of wheels are driven by a wheel drive assembly to enable movement of the vehicle in X and Y directions respectively along the rails. A directional change mechanism is configured to vertically lift one or both sets of wheels clear of the respective rails, thereby allowing the vehicle to move in the desired direction, e.g. X or Y direction on the grid structure. For example, the directional change mechanism is configured to selectively lift the second set of wheels in order for the load handling device to travel along the first direction and the first set of wheels in order for the load handling device to travel along the second direction.

WO2017/153583 (Ocado Innovation Limited) teaches a load handling device comprising a wheel positioning mechanism or directional change mechanism for enabling lateral movement of the device in one of two transverse directions by enabling either a first or second set of wheels to selectively engage the first or second set of rails or tracks (62a or 62b). The wheel positioning mechanism comprises a complicated arrangement of linkages driven by a linear actuator or motor to selectively lower or raise the first set of wheels or the second set of wheels into engagement or disengagement with the first set of tracks or rails or the second set of tracks or rails.

The load handling device 80 is equipped with a lifting mechanism or container lifting mechanism or crane mechanism to lift a storage container from above. The crane mechanism comprises a tether or cable 88 wound on a spool or reel (not shown) and a grabber device or container-gripper assembly 89 in the form of a lifting frame. The term “grabber device” and “container-gripping assembly” are used interchangeably in the patent specification to mean the same feature. The lifting mechanism comprise a set of lifting tethers 88 extending in a vertical direction and connected nearby or at the four corners of the lifting frame 89 (one tether near each of the four corners of the lifting frame) for releasable connection to a storage container 62. The grabber device 89 is configured to releasably grip the top of a storage container 62 to lift it from a stack of containers in a storage system of the type shown in FIGS. 10 and 11.

The wheels 84, 86 are arranged around the periphery of a cavity or recess, known as a container-receiving recess 91, in the lower part. The recess is sized to accommodate the container 62 when it is lifted by the crane mechanism, as shown in FIG. 14(a and b). When in the recess, the container is lifted clear of the rails beneath, so that the vehicle can move laterally to a different location. On reaching the target location, for example another stack, an access point in the storage system or a conveyor belt, the bin or container can be lowered from the container receiving portion and released from the grabber device. The container receiving space may comprise a cavity or recess arranged within the vehicle body, e.g. as described in WO 2015/019055 (Ocado Innovation Limited). Alternatively, the vehicle body of the load handling device may comprise a cantilever as taught in WO2019/238702 (Autostore Technology AS), in which case the container receiving space is located below a cantilever of the load handing device. In this case, the grabber device is hoisted by a cantilever such that the grabber device is able to engage and lift a container from a stack into a container receiving space below the cantilever.

Power to the drive units for operating the lifting mechanism and the wheel positioning mechanism is provided by a rechargeable power source. The load handling device further comprises one or more auxiliary electrical components, e.g. a controller, one or more wire looms to carry information from the controller and/or power from the rechargeable power source to the drive units of the load handling device. One or more load handling devices remotely operable on the grid structure are configured to receive instructions from a master controller to retrieve a storage container from a particular storage location within the grid framework structure. Wireless communications and networks may be used to provide the communication infrastructure from the master controller via one or more base stations to the one or more load handling devices operative on the grid structure. A controller in the load handling device in response to receiving the instructions is configured to control various driving mechanisms to control the movement of the load handling device. For example, the load handling device may be instructed to retrieve a container from a storage column at a particular location on the grid structure. The instruction can include various movements in an X-Y direction on the grid structure 74. Once at the storage column, the lifting mechanism is then operated to grab the storage container and lift it into a container receiving space in the body of the load handling device where it is subsequently transported to a another location on the grid structure commonly known as a drop off port. The container is lowered to a suitable pick station allow retrieval of the item from the storage container. Movement of the load handling devices on the grid structure also involves the load handling devices being instructed to move to a charging station which is usually located at the periphery of the grid structure. The load handling device remains stationary at the charging station while the battery is recharged. The charging period is a significant source of downtime for the load handling device and can be on the order of hours. The rechargeable power source and the auxiliary electrical components of the load handling device are typically housed within the body of the load handling device.

Typically, the load handling device in the art comprises a separate rigid framework or chassis and the functional components of the load handling device such as the container lifting mechanism, wheel positioning mechanism, wheel assembly, wheel drive assembly and the electrical components, e.g. rechargeable power source and/or control unit are literally fixed or mounted to the framework. Fixing includes various fasteners such as bolts, screws and/or welding. The framework is usually in the form of a tower having a height that is representative of the height of the load handling device. To ensure that the structural integrity of the rigid framework or chassis can bear the weight of the various functional components of the load handling device, the rigid framework is commonly constructed from metal, e.g. aluminium or stainless steel. Cladding is fixed to the outside of the framework to form a vehicle body housing the functional features of the load handling device. The accumulation of the weight of the rigid framework and the various functional components of the load handling device results in a load handling device having a weight in excess of 150 kg. Due to the weight of the load handling device, the grid framework structure 66 needs to have sufficient structural integrity to bear the weight of multiple load handling device operable on the grid framework structure. Various bracing elements are used to increase the strength of the grid framework structure which ultimately adds to the costs of the grid framework structure, and thus the overall cost of the storage and retrieval system. As the weight of the load handling device increases, more power is also required to drive the wheel motors to move the load handing device on the tracks at a sufficient speed, which in turn translates into bigger and more powerful electrical motors and a bigger battery to provide the necessary power to drive the electrical motors.

Moreover, the number of components, which includes various motors, pulleys and electrical components such as a battery and control board needed for the load handling device to operate on the grid framework structure, assembling the individual components together is one of biggest costs in the manufacture of a load handling device. Considering that there are hundreds of load handling devices operable on the grid framework structure, the cumulative costs of multiple load handling devices operable on the grid structure represent a significant proportion of the cost of a typical storage and retrieval system. Not only are the costs in the manufacture of the load handling devices representative of a significant proportion of the costs of the retrieval and retrieval system but also the weight of the load handling device which can weigh in excess of 150 kg can lead to other additional costs. A load handling device is thus required that is easy to assemble, is lightweight and lower cost to manufacture.

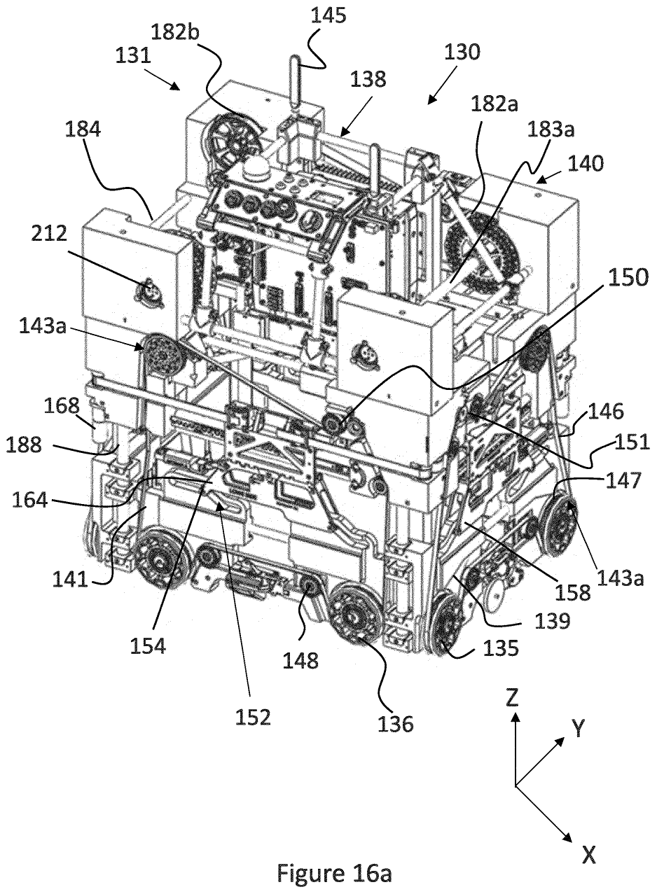

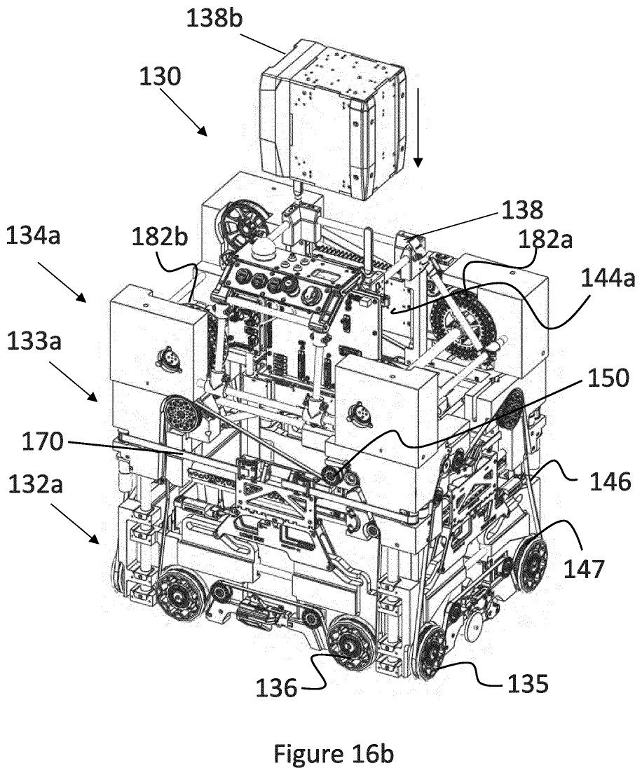

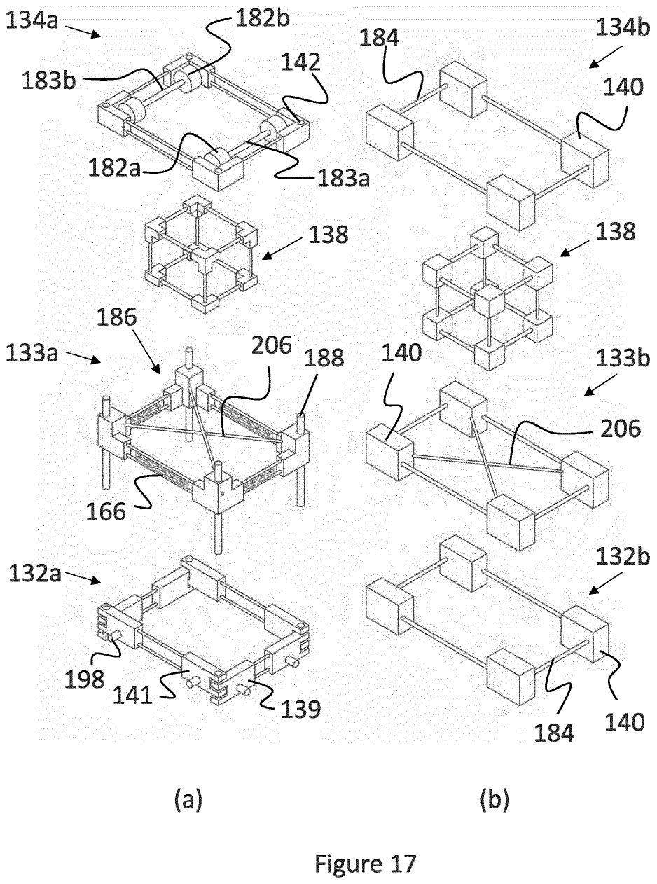

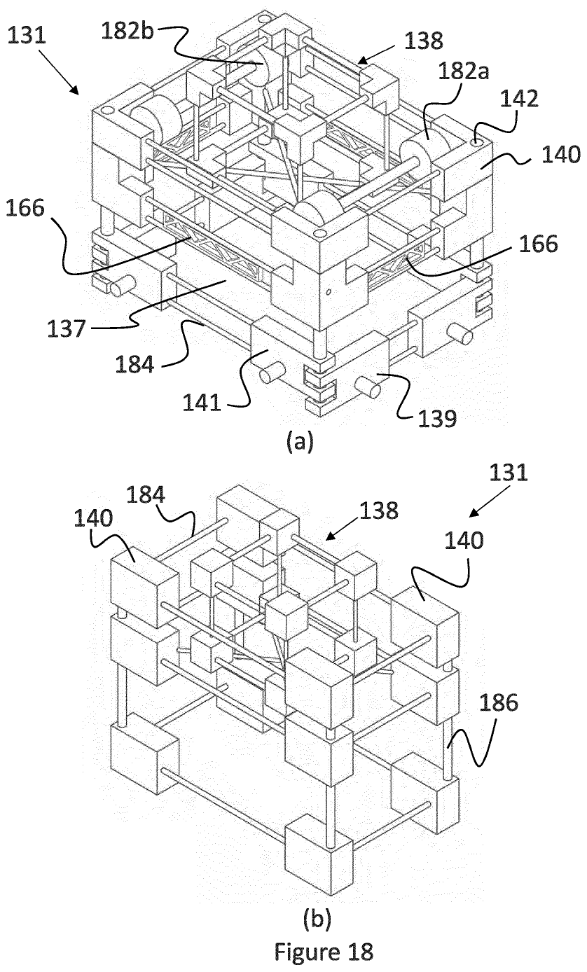

In accordance with an embodiment of the present invention, the construction of the load handling device 130 is based around the principle of having a modular system comprising a plurality of modules or modular sub-frames that are connectable in a vertical stack to provide the different functional characteristics of the load handling device. In comparison to the load handling device in the art, the load handling device according to the embodiment of the present invention does not have any cladding and largely comprises an open frame structure 131. An example of a load handling device 130 incorporating the inventive concepts of the present invention is shown in FIG. 16(a and b) and the different modular sections 132(a and b) to 134(a and b) providing the different functional characteristics of the load handling device are shown in FIG. 17(a and b) and a schematic drawing of the different modular sub-frames making up the load handling device is shown in FIG. 18(a and b). FIG. 18a is a schematic drawing showing a simplified version of the frame 131 supporting the main operational components of the load handling device and is the result of the assembly of the modular sub frames 132a, 133a, 134a shown in FIG. 17a. FIG. 18b is a more simplified drawing demonstrating the building blocks 140 of the load handling device shown in FIG. 17a and is the result of the assembly of the modular sub-frames 132b, 133b, 134b shown in FIG. 17b. Each of the modular sections 132(a and b) to 134(a and b) is provided by a modular sub-frame that are connectable together to form the frame 131 of the present invention. In the particular embodiment of the present invention, the frame 131 is configured as an open frame structure. However, the present invention is not limited to the frame being an open frame structure and the frame can optionally comprises external cladding mounted to the exterior of the frame. For the purpose of explanation of the present invention, the frame in the specific embodiment shown in FIG. 16(a and b) will be described as an open frame structure.

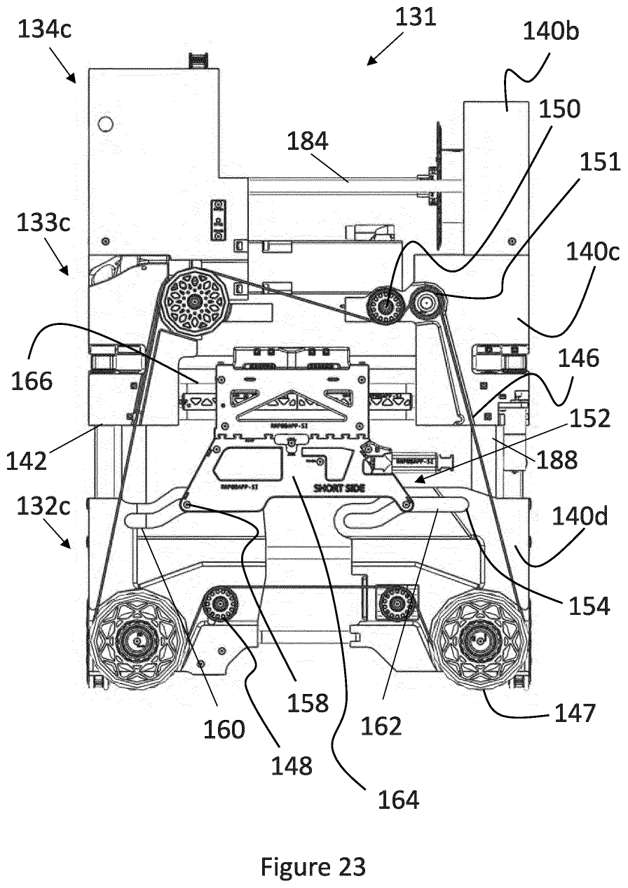

As can be appreciated from an exploded view of one face of the load handling device shown in FIG. 23, the different modular sub-frames 132c, 133c, 134c of the load handling device comprise connection points 142 at the corners of the modules 132c, 133c, and 134c to enable the different modular sub frames 132c, 133c, 134c to be vertically stacked. In the particular embodiment of the present invention shown in FIG. 17(a and b) and FIG. 18(a and b), three modular sections 132(a, b, c), 133(a, b, c), and 134(a, b, c) are shown connectable in a vertical stack to form a tier based modular system. Starting from the bottom modular section 132(a, b, c) and increasing in height of the load handling device, the three modular sections for the purpose of explanation of the present invention are labelled first 132(a, b, c), second 133(a, b, c), and third 134(a, b, c) modular sections that are each provided by their respective modular sub-frames. The three modular sections provide the different functional characteristics of the load handling device. In the particular embodiment of the present invention, the different functional characteristics of the load handling device can be shared amongst one or more of the modular sections 132(a, b, c), 133(a, b, c), and 134(a, b, c) of the load handling device 130. For example, the wheel positioning mechanism and the wheel drive assembly can be shared amongst two or more modular sections of the load handling device. The number of modular sections is not limited to three modular sections and the different functional characteristics of the load handling device can be divided amongst any number of modular sections.

The different functional characteristics of the load handling device include but are not limited to the wheel assembly for allowing movement of the load handling device on the grid structure or tracks, a wheel drive assembly to drive the wheel assembly to enable the load handling device to move on the grid structure, the wheel positioning mechanism, otherwise known as the directional change mechanism, the container lifting mechanism for picking up and dropping off a storage container to and from a grid cell of the grid framework structure, and the electrical or electronic components of the load handling device.

As shown in FIG. 16(a and b), the wheel assembly comprises a pair of wheels at the front 135 and a pair of wheels at the rear of the load handling device 130. For simplicity of explanation, the wheel assembly comprises a pair of wheels 135 at the front of the load handling device and a pair of wheels at the rear of the load handling device, collectively is termed a first set of wheels 135. The first set of wheels 135 are orientated so that the load handling device is able to move in a first direction, i.e. X Cartesian direction. Similarly to the first direction, to move in a second direction, the second direction being substantially perpendicular to the first direction, i.e. Y Cartesian direction, so that the load handling device can move in both X-Y directions on the grid structure, the wheel assembly comprises pairs of wheels 136 on either side of the load handling device, and for simplicity of explanation these wheels are termed a second set of wheels 136. Thus, to move in the first direction on the grid structure, the first set of wheels 135 engage with the grid structure and the second set of wheels 136 disengage from the grid structure. Similarly, to move in the second direction, the first set of wheels 135 disengage from the grid structure and the second set of wheels 136 engage with the grid structure. The wheels are rotatably mounted to the open frame structure 131 via one or more wheel mounts 139, 141 (see FIGS. 18a and 22) and are configured to engage with the grid structure to allow the load handling device to move along the grid structure in both X and Y directions.

As discussed above, the electrical components can optionally comprise a control unit or controller 144a for controlling the operation of the wheel drive assembly, the wheel positioning mechanism and the lifting drive mechanism of the container lifting mechanism. Typically, the wheel drive assembly, the wheel positioning mechanism and the drive mechanism of the container lifting mechanism comprise one or more electrical motors. Other electrical components of the load handling device include but are not limited to a communication module for receiving instructions from an external central control system. The communication module comprises a receiver for receiving instructions from an external control unit via a base station and a transmitter for transiting a signal via an antenna 145 comprising data associated with the positioning and/or status of the load handling device on the grid structure. The controller 144a in communication with the communication module controls the movement of the load handling device on the grid structure in response to receiving the instructions from the external central control system.

In the example of the robotic load handling device shown in FIG. 16(a and b), the load handling device 130 further comprises a receptacle 138 that functions as a battery chute within the open frame structure 131 for accommodating the power source 138b (see FIG. 16b). In other words, the receptacle 138 is “buried” within the open frame structure 131 such that the receptacle 138 extends vertically through at least one of the modular sub-frames 132, 133, 134 of the open frame structure 131. For the purpose of definition, the term “extends vertically through” also encompasses extending vertically through a horizontal plane to which the at least one of the plurality of modular sub-frames lies in. The receptacle 138 provides a separate area within the open frame structure for the power source 138b to be lowered into the open frame structure without impinging on the other components of the load handling device. The receptacle is depicted as having a cuboidal shape but may have other shapes, such as a cylindrical shape and is largely dependent on the shape of the power source or its casing. The top end of the receptacle is open that is externally accessible from above the load handling device so as to enable a power source to be lowered into the receptacle. The receptacle 138 comprises one or more electrical connectors or charge receiving elements that is configured to electrically couple to the charge providing elements of the power source. The charge receiving elements are configured to connect to the charge providing elements of the power source when the power source is vertically received in the receptacle and disconnect when the power source is vertically removed from the receptacle.

In detail, each modular section can be envisaged as a rectangular open frame or rectangular modular sub-frame formed by connecting or linking together corner brackets (see FIG. 18(a and b)), where each corner bracket is shown as a connecting block in FIG. 18b. A modular section is built by connecting adjacent connecting blocks in the same horizontal plane by one or more connecting elements 187 to form an open rectangular frame or modular sub-frame 186. Vertically adjacent rectangular modular sub-frames or modular sub-frames 186 are thus connected together by connecting vertically adjacent connecting blocks 140 as shown in FIG. 17(a and b) to form the open frame structure 131. An example of a connecting block 140 is a corner bracket. In a singular modular section, each connecting block is connected to two other connecting blocks in the same horizontal plane by one or more connecting elements 184. The connecting elements can be connecting rods or tubes for linking adjacent connecting blocks (corner brackets) together in a single modular section. The connecting rods can be solid or hollow and is dependent on the connection with the connecting block as discussed above. In the particular embodiment of the present invention, the open frame structure is a three dimensional structure defining a volume having an upper portion comprising the receptacle 138 (see FIG. 16(a and b)), the control unit 144a, spools 182(a and b) carrying the lifting tethers, and a lower portion comprising the container receiving space 137.

The structural integrity of the open frame structure should be sufficient to not only support the different functional characteristics of the load handling device but also have sufficient flexural rigidity when the load handling device is operational on the grid structure. Various materials can be used in the fabrication of the connecting rods or tubes. These include but are not limited to metal or polymers (e.g. plastics) or ceramic or a combination thereof. To reduce the weight of the load handling device and have the necessary structural properties to support the different functional components of the load handling device, optionally the connecting rods linking adjacent connecting blocks together are composed of carbon fibre bound in a polymer matrix (known as carbon fibre rods). The connecting rod is fixed to the connecting block by being received in a socket in the connecting block and subsequently, adhered to the connecting block by injection of adhesive into the socket via the inlet as discussed above with reference to FIGS. 1 to 9.

A simplified modular section is where the connecting block 140 is a corner bracket such that a modular section comprises four corner brackets. Each of the four corner brackets is directly connected to two other corner brackets in the same horizontal plane to form a simple open rectangular frame or sub-frame as shown in FIG. 17b. However, the corner brackets in a single modular section can be indirectly connected to two other corner brackets by one or more corner brackets intermediate of the corner brackets at the corners of the rectangular frame. Thus, the term “connected” with reference to the corner brackets in each of the modular sections can be broadly construed to mean directly and/or indirectly connected to two other corner brackets.

To construct the load handling device according to the present invention, the different modular sections can be linked together by simply linking vertically adjacent rectangular modular sub-frames 186 together by one or more vertical connecting elements 188 via their respective connecting block or corner brackets 140 to form an open frame structure 131 as shown in the simplified open frame structure in FIGS. 17a and 17b. In other words, the same connecting blocks or corner brackets for connecting to two other connecting blocks or corner brackets in a single modular section can be used to vertically connect adjacent rectangular modular sub-frames together. The corner brackets of vertically adjacent rectangular sub-frames can be mounted to the same vertical connecting element 188 at each corner of the open frame structure such that the vertical connecting element extends though the corner brackets of multiple vertically adjacent rectangular, modular sub-frames. As a result, each of the corners of the open frame structure share the same or common vertical connecting element. To link multiple rectangular sub-frames to the same vertical connecting element at each corner of the open frame structure via their respective corner brackets, the socket in the corner brackets (connecting blocks) intermediate or between the bottom and top rectangular modular sub-frames is a through hole for the vertical connecting element to extend through the corner bracket at each corner when linking together vertically adjacent rectangular sub-frames 186 (see 2^{nd} modular section in FIG. 17a). This has the advantage that multiple rectangular sub-frames 186 can be vertically linked together in a stack simply by mounting the multiple rectangular sub-frames to the same vertical connecting element at each corner of the open frame structure to form the load handling device as shown in FIG. 17(a and b). This is clearly apparent in the schematic drawing of one face of the open frame structure shown in FIG. 23. Here the vertical connecting element is shown extending through multiple connecting blocks at the corners of the open frame structure.

Alternatively, separate vertical connecting elements can be used to connect vertically adjacent rectangular modular sub-frames at each corner of the open frame structure. The length of the vertical connecting elements connecting vertically adjacent rectangular modular sub-frames dictates the height of the open frame structure. The connecting elements 188 linking vertically adjacent rectangular modular sub-frames together can be same type or a different type to the connecting elements linking adjacent corner brackets in a given modular sub-frame lying in a horizontal plane. For example, the connecting elements 188 linking vertically adjacent rectangular modular sub-frames together can be a connecting rod that is used to link the corner brackets in a single modular section. Alternatively, the connecting elements 188 linking vertically adjacent rectangular modular sub-frames together can be solid connecting rods and the connecting elements linking the corner brackets in a given modular sub-frame lying in a horizontal plane can be hollow tubes. The linking together of the corner brackets forming the connecting blocks by horizontal 187 and vertical 188 connecting rods is exemplified by the pre-assembly of the 2^{nd} modular section shown in FIG. 19 comprising the support or rail 166 for the wheel positioning mechanism discussed above.

A similar process of linking connecting blocks with horizontal connecting elements applies to the assembly of the 1^{st} and 3^{rd} modular sections. Each corner bracket or connecting block 140 comprises one or more sockets 187 that are shaped to receive one or more connecting elements 184, 188 for linking the connecting blocks together to form a single modular section and for linking vertically adjacent modular sections together in a vertical stack. The arrows in FIG. 19 show the direction of the connecting elements 184 when being inserted into their respective sockets 187 in the connecting blocks or corner brackets 140 and correspond to the direction along the first axis of their respective sockets. In the particular example shown in FIG. 19, one or more of the sockets in each of the connecting blocks 140 is a blind hole and one or more of the remainder of the sockets is a through hole. The blind hole is for linking each of the connecting blocks with two other connecting blocks with connecting elements in the same horizontal plane to form a single modular sub-frame and the through hole in each of the connecting blocks allows vertically adjacent modular sub frames to be connectable in a vertical stack by one or more of the substantially vertical connecting elements.

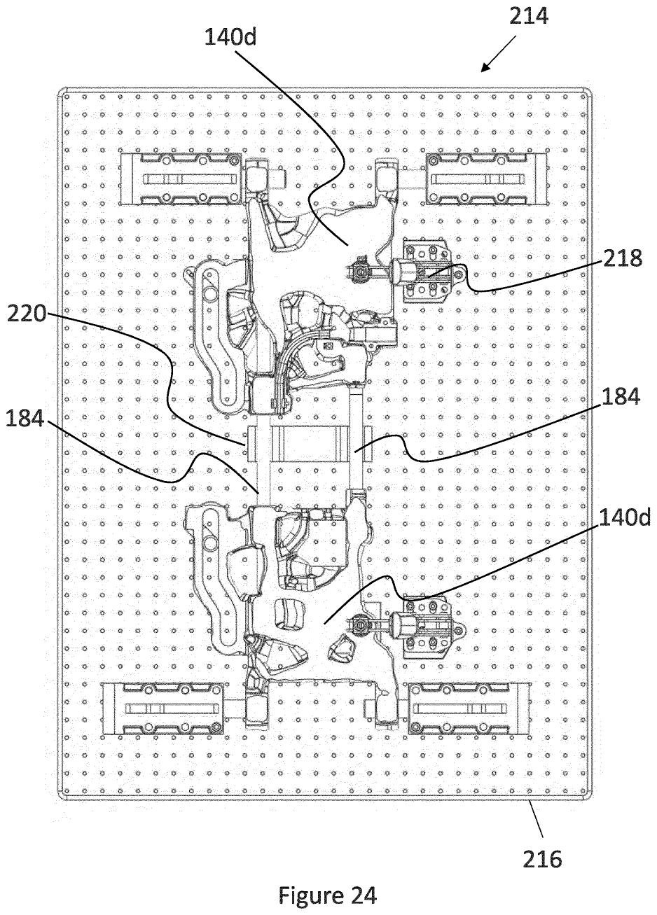

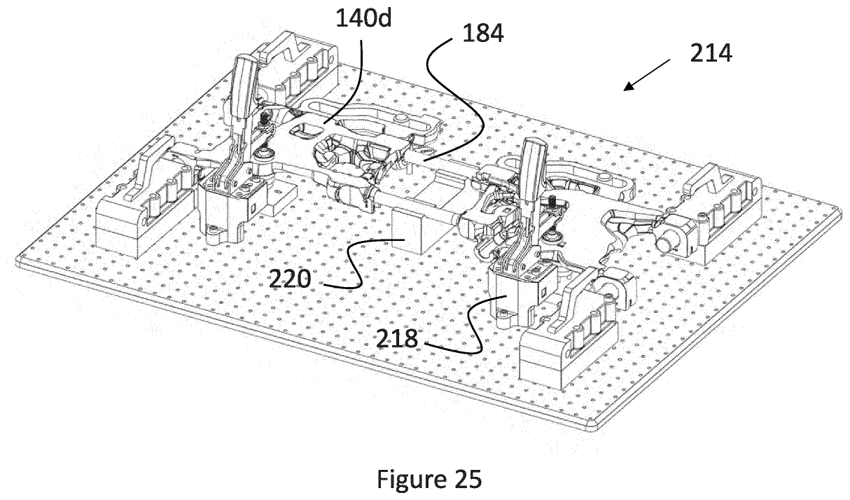

Adhesive is injected into the sockets to secure the connecting elements to their respective connecting block. As discussed above, the cross-sectional dimension of the sockets 187 in the connecting blocks 140 are made slightly oversized to enable the orientation of the connecting rods 187, 188 to be adjusted relative to its respective connecting block 140. The plurality of radially extending fingers or fins disposed in the sockets at least entraps the adhesive injected into the socket when securing the connecting element to the connecting block. This is particularly important where a connecting block is orientated in the frame such that the longitudinal axis of the socket is substantially vertical. This is because there is a risk that the adhesive injected into the socket would either pool at the bottom of the socket or escape the socket due to gravity, particularly if the mouth of the socket is facing downwards. The plurality of fingers or fins distributed around the internal wall of the socket acts as a barrier so as to at least prevent the adhesive pooling or escaping from the socket prior to curing. To assist with the alignment or proper orientation of the connecting elements to their respective connecting block in an assembly, a jig or fixture is used as demonstrated in FIGS. 24 and 25. Further detail of the assembly of at least a portion of the frame in a jig or fixture of the robotic load handling device is discussed below.

To simplify the construction of the load handling device whilst still accommodating the different functional characteristics of the load handling device, at least a portion of the functional components of the load handling device is integrated into the open frame structure 131 of the load handling device 130, in the sense that at least a portion of the functional components of the load handling device are integral with one or more of the rectangular frames or modular sub-frames of the load handling device. For example, at least a portion of the wheel assembly is integral with one or more rectangular modular sub-frames, at least a portion of the wheel drive assembly is integral with one or more rectangular modular sub-frames, at least a portion of the wheel positioning mechanism is integral with the one or more rectangular modular sub-frames and/or at least a portion of the container lifting mechanism is integral with one or more rectangular modular sub-frames.

To integrate at least a portion of the different functional characteristics of the load handling device into one or more of the rectangular modular sub-frames making up the open frame structure of the load handling device, one or more of the connecting blocks 140 of one or more of the rectangular sub-frames 186 is fabricated with the functional characteristics of the load handling device in mind. To integrate the different functional characteristics of the load handing device into one or more of the modular sub-frames, at least a portion of one or more of the functional components of the load handling device is integrated into one or more connecting blocks of one or more of the rectangular modular sub-frames. For example, one or more of the connecting blocks linking the rectangular modular sub-frames together may be integrally formed with one or more mounts for a spool, pulley and/or motor rather than having separate mounts for mounting to the frame of the load handling device.

Different connecting blocks can be used to construct the different modular sections and the choice of connecting block is largely dependent on the different functional characteristics of the load handling device. The shape of the connecting blocks becomes more complex as the complexity of the functional characteristics of the load handling device increases. Examples of the various connecting blocks 140(b to d) in a simplified form that form the corner brackets of the open frame structure is shown in FIGS. 20 to 22 and represent the different corner brackets for assembling the rectangular modular sub-frames of the different modular sections of the load handling device.

Various lightweight materials can be used in the fabrication of the connecting blocks. Examples of lightweight materials include but are not limited to various lightweight metals, e.g. aluminium or various polymeric materials, e.g. plastic materials, or composite materials (e.g. carbon fibre/polymer composite). Various methods can be used to fabricate the connecting blocks. These include but are not limited to machining from a block, injection moulding or casting. However, as the complexity of the connector blocks increases, particularly when at least a portion of the functional component of the load handling device is made integral with the connecting blocks 140, 140(b to d), more sophisticated fabrication methods can be used. The use of additive manufacturing such as 3D printing provides the ability to fabricate complex connecting blocks such that at least a portion of the functional component of the load handling device can be integrally formed with one or more of the connecting blocks. The use of additive manufacturing in the fabrication of the connecting blocks, particularly, the corner brackets, allows one or more of the connecting blocks to be topology optimised to take into account the stresses that the connecting blocks would experience in the open frame structure. Moreover, additive manufacturing allows the plurality of fingers or fins to be integrally formed with the connecting block. This is because additive manufacturing or 3D printing has the ability to form complex shapes that cannot be achieved by machining alone. This is particularly the case where the connecting blocks are topology optimised since the outcome of topology optimization tends to result in complex shapes in order to take into account various load constraints that the connecting block would encounter in application in the open frame structure of a load handling device.

Dealing with the different functional characteristics of the load handling device, the wheels of the wheel assembly are supported by the rectangular modular sub-frame 186 at the bottom or first modular section. To accommodate the wheels of the wheel assembly, each of the connecting blocks of the bottom or first modular section is integrally formed with one or more wheel mounts 139, 141 of the first and second sets of wheels. In the particular embodiment of the present invention shown in FIGS. 18a and 22, each of the connecting blocks of the bottom modular section is formed in two parts for accommodating two wheel mounts, namely a first and second wheel mount 139, 141. The first wheel mount 139 is configured for mounting a wheel of the first set of wheels 135 and the second wheel mount 141 is configured for mounting a wheel of the second set of wheels 136 (such that there is a total of eight wheels mounted to four connecting blocks 140d; two wheel mounts for each of the four connecting blocks 140d and arranged to support the open frame structure of the load handling device). In other words, each of the four connecting blocks 140d of the first or bottom modular section is integrally formed with two wheel mounts; the first and second wheel mounts 139, 141. To accommodate two wheel mounts in one connecting block 140d, the two wheel mounts of a given connecting block are assembled substantially perpendicularly to each other so that the first wheel mount 139 provides a mount for a wheel for moving the load handling direction in the first direction and the second wheel mount 141 provides a mount for moving the load handling device in a substantially perpendicular direction (see FIG. 22). In the particular embodiment of the present invention shown in FIG. 22, the first and second wheel mounts 139, 141 of the connecting blocks comprise a shaft or spigot 198 for rotatably mounting a respective wheel. The shaft or spigot 198 can be integrally formed with the connecting block as shown in FIG. 22.

Each connecting block for mounting the wheels of the wheel assembly is connected to two other connecting blocks to form a rectangular modular sub-frame by one or more connecting elements 184. In the particular example of the present invention shown in FIGS. 17a and 18a, each of the connecting blocks 140d is connected to two other connecting blocks in the same horizontal plane by two connecting elements 184 receivable in openings or sockets 187 in the connecting blocks (see FIG. 22). However, the number of connecting elements 184 for connecting adjacent connecting blocks in the same horizontal plane to form a rectangular modular sub-frame of the 1^{st} modular section comprising the wheel assembly is not limited to two connecting elements and can be any number of connecting elements to provide the necessary structural rigidity of the rectangular frame.

To drive rotation of the first and second sets of wheels, at least a portion of the wheel drive assembly discussed above can be integrated into one or more of the rectangular sub-frames of the open frame structure of the load handling device. In the particular example of the present invention, each of the first and second sets of wheels are driven by one or more motors (not shown) via a drive belt assembly 143a described in the PCT Application PCT/EP2021/055372 in the name of Ocado Innovation Limited, the details of which are incorporated herein by reference. In the particular embodiment shown in FIG. 16(a and b), a drive belt assembly 143a is provided for each set of wheels and comprises a drive belt pulley gear arrangement 143b for engaging with an edge of a pair of wheels 135, 136 on one side of the load handling device. The rim of the pairs of wheels comprises a plurality of gear teeth 147 for cooperating with a drive belt 146. A toothed drive belt 146 engages with both of the wheels. The drive belt 146 is guided by a slave-wheel 148 mounted to the open frame structure 131 of the load handling device 130, and to the tensioning wheel arrangements 150. The tensioning wheel arrangements 150 are movably mounted to the open frame structure 131 with springs (not shown), and are intended to keep the drive belt 146 taut and maintain engagement of the drive belt 146 with the wheels. A drive wheel 151 is provided, mounted to the open frame structure 131 (see FIG. 23). The drive wheel 151 is driven by the pulley and gear arrangement 143b which is linked to an axle or drive shaft of a motor (shown in FIG. 23). Rotation of the drive wheel 151 by the motor drives a pair of wheels by being connected the drive belt 146. The wheel drive assembly is provided for each of the pair of wheels of the first 135 and second 136 set of wheels. Thus, each of the pairs of wheels of the first set of wheels 135 are driven in synchronization by their respective drive assemblies to move the load handling device in the X direction on the grid structure. Similarly, each of the pairs of wheels of the second set of wheels 136 are driven in synchronization by their respective drive assemblies to move the load handling device in the Y direction on the grid structure.

The mounts for the drive and the slave wheels for carrying the drive belt can be integrally formed with one or more of the connecting blocks 140d (see FIGS. 21 and 22) of one or more of the rectangular sub-frames. For example, in the particular embodiment of the present invention shown in FIG. 22, each of the corner brackets 140d comprising the wheel mounts 139, 141 for the wheel assembly additionally comprises a mount 200 for the slave wheels 148 of the drive belt assembly 143a such that the drive belt 146 travels around the outer periphery of the wheels 135, 136 mounted to the corner bracket 140d and around the slave wheel 148 on the same corner bracket 140d (see FIGS. 16 and 22). As each corner bracket 140d is integrally formed with two wheel mounts 139, 141 for the wheels orientated perpendicular to each other to cover the travelling directions of the load handling device on the grid structure, the mounts 200 for their respective slave wheels can be integrally formed with each of the wheel mounts 139, 141 of the corner bracket 140d.

The drive pulleys151 for driving the rotation of a pair of wheels of the first or second set of wheels are mounted to the corner brackets 140c of the rectangular modular sub-frames located higher in the vertical stack such that drive belt 146 extends around a pair of wheels at one side face of the load handling device and around the drive wheels mounted to the higher modular sections (see FIG. 23). In the particular embodiment of the present invention, the drive wheels for driving the drive belt of each wheel drive assembly are mounted to a shaft or spigot 202 integrally formed with the corner brackets 140c forming the rectangular modular sub-frame of the second modular section (see FIG. 21). As a result, a pair of wheels of each of the first and second sets of wheels are driven by a drive belt that connects the slave wheels in the first modular section 132a and the drive wheels mounted to the corner brackets of the second modular section 133a. This is repeated for the other drive assemblies at each side face of the load handling device as shown in FIG. 16a. Also shown in FIG. 16a is that each wheel drive assembly 143a for driving a pair of wheels additionally comprises the tensioning wheel arrangement 150 discussed above to ensure that the drive belt around a given pair of wheels remain taut. In the particular example of the load handling device shown in FIG. 16, one or more of the corner brackets of the rectangular frame supporting the wheels also comprises the wheel tensioning arrangement.

The drive assembly is not limited to the drive belt assembly discussed above and the connecting blocks of the rectangular modular sub-frame carrying the wheels of the wheel assembly can be integrated with a mount for carrying a hub motor discussed above. Thus, each corner bracket of the rectangular modular sub-frame of the first or bottom modular section can be integrally formed with a mount for a drive assembly comprising a hub motor; wherein the inner hub of the hub motor is mounted to the corner bracket. Since each of the corner brackets of the first or bottom modular section is formed with two wheel mounts for mounting two wheels, each corner bracket is integrally formed with two mounts for mounting two hub motors; one to mount a wheel for travelling in the first direction and the other to mount a wheel for travelling in the second direction.

To change direction on the grid structure, the load handling device comprises a wheel positioning mechanism. Various wheel positioning mechanisms are known in the art, some of which are discussed above. Considering that sufficient force is required to vertically lift a pair of wheels of a given set of wheels relative to the open frame structure, at least a portion of the wheel positioning mechanism is mounted to a rectangular sub-frame of the open frame structure that has been reinforced to bear the weight of the pair of wheels at each side face of the load handling device. In the particular example of the load handling device shown in FIG. 16(a and b) and 19, the rectangular sub-frame of the second modular section is reinforced by one or more struts or braces 206 and is termed as “a middle halo” since it is located substantially middle of the height of the load handling device, i.e. between the 1^{st} and 3^{rd} modular sub-frames (see FIG. 17a). Reinforcement of the middle halo is provided by one or more cross braces 206 extending across the rectangular modular sub-frame. The particular example of the wheel positioning mechanism shown in FIGS. 16 and 23 is based on a cam mechanism 152 taught in PCT/EP2022/073670, the details of which are incorporated by reference in its entirety. The cam mechanism 152 comprises a cam 154, a cam follower 158 moveable along the cam 154, a traveller 164 for moving the cam follower and a cam motor 168 coupled to the traveller 164.

The traveller 164 is configured to move along a rail 166 on one side face of the load handling device to raise a pair of wheels. The rail 166 for supporting the traveller for raising a pair of wheels comprises the horizontal connecting elements 184 extending between the connecting blocks of the rectangular modular sub-frame of the middle halo such that the traveller moves along the connecting elements 184 connecting the connecting blocks 140 on one side face of the load handling device. The connecting elements 184 for supporting the traveller 164 of the middle halo thus functions as an overhead rail (see FIG. 19). In the particular example of the present invention shown in FIG. 23, the traveller 164 is slideably mounted to the connecting elements connecting the connecting blocks in the same horizontal plane. This is repeated for the other pairs of wheels at each of the side faces of the load handling device. To support the traveller, at least two connecting elements 184 extend between the connecting blocks 140 on one side face of the load handling device. One or more inserts 208 are sandwiched between the two connecting elements 184 extending between the corner brackets 140 to provide flexural rigidity of the connecting elements extending between the corner brackets 140 to prevent excessive bending of the connecting elements when the traveller moves along the connecting elements.

In the particular example of the present invention, the cam mechanism for each of the pairs of wheels of the first and second sets of wheels is based on a double cam arrangement; wherein the traveller is configured to raise and lower a given pair of wheels via the double cam arrangement. The cam for cooperating with the cam follower can be mounted to the connecting blocks supporting the wheels of the wheel assembly or be integrally formed with the connecting block. As the cam follower travels along the cam, an upward or downward force is applied to a respective connecting block carrying a wheel of the first or second sets of wheels which causes the wheel to raise or lower depending on the direction of travel of the load handling device on the grid structure. The cam 154 for cooperating with the cam follower 158 can be integrally formed with its respective connecting block 140d comprising the wheel mounts of the wheel assembly as shown in FIG. 16(a and b) and FIG. 22. Two cams 154 are shown integrally formed with the corner bracket 140e, one for each of the wheel mounts 139, 141. As can be appreciated from the description above in connection with FIGS. 16 and 22, at least a portion of the wheel positioning mechanism is integrally formed with the connecting blocks of one or more rectangular modular sub-frames forming the different modular sections of the load handling device.

In the particular embodiment of the present invention, the cam motor 168 is configured to move the traveller 164 along one side of the load handling device by a cam belt 170 having one end anchored to the cam motor 168 and the other end anchored to the traveller 164. The cam belt 170 is wound on a cam spool mounted to the drive shaft of the cam motor 168 such that rotation of the cam spool by the cam motor 168 provides a pulling force on the cam belt 170, which in turn causes the traveller 164 anchored to the cam belt 170 to move along the rail 166. To return the traveller 164 to its initial position, a second motor can provide an opposite pulling force on the traveller 164 to pull the traveller in the opposite direction.

Also shown in FIG. 16a is that the cam motor 168 for moving the traveller along the connecting elements is mounted to the connecting blocks 140c of the rectangular modular sub-frame forming the middle halo of the open frame structure. One or more mounts for one or more motors are integrally formed with the connecting blocks, more specifically the corner brackets of the rectangular frame of the middle halo. As shown in FIG. 21, one or more openings 210 are integrally formed in the corner bracket 140c for receiving a motor shaft of the motor. The corner bracket 140c also supports a spool for taking up the cam belt as the spool rotates such that when the cam motor 168 rotates in a clockwise direction, the cam belt is wound on the spool and when the cam motor 168 rotates in an anti-clockwise direction, the cam belt is unwound from the spool. Clockwise and anti-clockwise rotation of the spool respectively moves the traveller along the cam so as to effect the lifting or lowering of a pair of wheels.

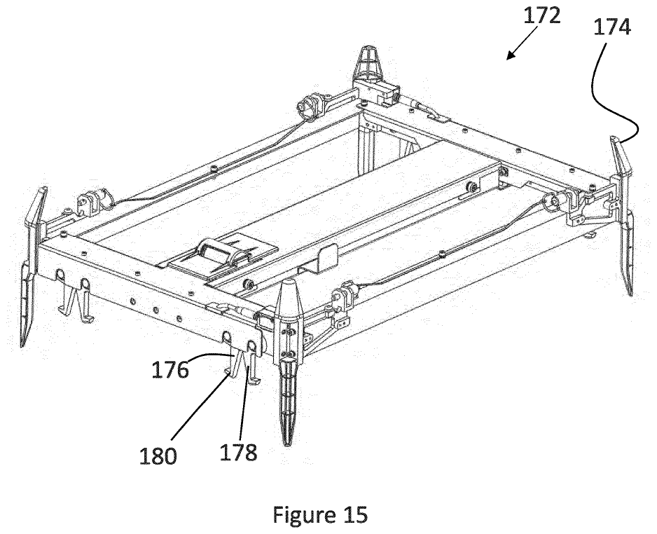

In addition to at least a portion of the wheel positioning mechanism being integrally formed with the connecting blocks or corner brackets forming the rectangular sub-frames of one or more modular sections, at least a portion of the container lifting mechanism, more specifically the winch assembly, can be integrally formed into the rectangular frame of one or more modular sections. The container lifting mechanism comprises first and second lifting shafts 183(a and b) for driving rotation of the four spools carrying the lifting tethers connected to the grabber device. The grabber device 172 shown in FIG. 15 comprises four locating pins or guide pins 174 nearby or at each corner of the grabber device 172 which mate with corresponding cut outs or holes formed at four corners of the container 10 and four gripper elements 176 arranged at the bottom side of the grabber device 172 to engage with the rim of the container. The locating pins 172 help to properly align the gripper elements 176 with corresponding holes in the rim of the container. Each of the gripper elements 176 comprises a pair of wings 178 that are collapsible to be receivable in corresponding holes in the rim of the container and an open enlarged configuration having a size greater than the holes in the rim of the container in at least one dimension so as to lock onto the container. The wings 178 can be driven into the open configuration by a drive gear. More specifically, the head of at least one of the wings comprises a plurality of teeth that mesh with the drive gear such that when the gripper elements 176 are actuated, rotation of the drive gear causes the pair of wings to rotate from a collapsed configuration to an open enlarged configuration. When in the collapsed or closed configuration, the gripper elements 176 are sized to be receivable in corresponding holes in the rim of the container. The foot of each of the pair of wings comprises a stop 180, e.g. a boss, such that when received in a corresponding hole in the rim of the container, the stop engages with an underside of the rim when in an enlarged open configuration to lock onto the container when the grabber device 172 winched upwards towards the container-receiving portion of the load handling device.

The first and second lifting shafts 183(a and b) are rotatably mounted to a rectangular sub-frame of a modular section. In the example shown in FIG. 17a, the first and second lifting shafts 183(a and b) are rotatably mounted to the rectangular sub-frame of the third modular section 134a, b, c. The first and second lifting shafts 183(a and b) are shown in FIGS. 17a and 18a extending across the rectangular modular sub-frame. The first and second lifting shafts are substantially parallel and spaced apart to define a space for accommodating the receptacle 138. Opposing ends of the first and second lifting shafts are shown rotatably mounted to a respective connecting block 140b via a shaft opening 212 in the connecting block as shown in FIG. 20. The shaft opening 212 in the connecting block is sized to rotatably receive an end of the lifting shaft 183(a and b). A bearing may be incorporated into the shaft opening 212 for mounting to the end of the lifting shaft 183(a and b) In the particular embodiment of the present invention, the container receiving space 137 (see FIG. 18a) for accommodating a storage container when lifted by the grabber device is housed within the open frame structure of the load handling device; more specifically in the region of the 1^{st}, 2^{nd} and the 3^{rd} modular sections (the 3^{rd} modular section supporting the spools carrying the lifting tethers). However, as vertically adjacent modular sections are connected together by their respective connecting blocks via vertical connecting elements, it is necessary that the grabber device is guided when it is lifted and lowered in and out of the container receiving space so as to prevent the grabber device fouling the connecting blocks. In the particular embodiment of the present invention, downwardly extending guides (not shown) are mounted to the connecting blocks 140c of the 2nd modular section of the load handling device, one at each corner of the rectangular frame so as to guide the grabber device as it is lowered or raised into the container receiving space 137. Each of the guides downwardly extends within the interior of the container receiving space and is shaped to comprise two perpendicular guiding plates for accommodating a corner of the grabber device shown in FIG. 15.

As the container lifting mechanism is configured to lift and lower a storage container which can weigh up to 40 kg, the connecting elements extending between the corner brackets can be braced by one or more bracing elements 206 to strengthen the rectangular frame of the modular section supporting the spools carrying the lifting tethers.

Manufacture of the frame of the load handling device involves separately building the different modular sub-frames 186 by inserting the connecting ends of the connecting elements into the openings or sockets 187 of the appropriate connecting blocks shown in FIGS. 20 to 22 to provide the different functional characteristics of the load handling device. A typical modular sub-frame comprises at least four connecting blocks, wherein each of the at least four connecting blocks in a single modular sub-frame is connected to two other connecting blocks by one or more of the connecting elements to form a substantially rectangular frame. Once the separate modular sub-frames are assembled to provide the different functional characteristics of the load handling device discussed above, vertical adjacent modular sub-frames are connected together in a stack by one or more vertical connecting elements to form the frame or frame structure. To help with reducing the weight of the load handling device according to the present invention, the connecting elements are typically hollow, e.g. hollow pipes. A similar assembling process can be used to fabricate the receptacle 138. A jig can be used to assemble the individual rectangular modular sub-frames together. The connection between the connecting blocks and the connecting elements are secured together in-situ in the jig by injection of adhesive into the sockets of the connecting blocks via their respective inlets. Since it is paramount that the resultant frame formed from the assembly of connecting elements and connecting blocks meets the required tolerance in terms of dimension and/or size, it is necessary that the adjustments can be made to the connecting elements.

FIGS. 24 and 25 are examples of a jig or fixture 214 to pre-assemble at least a portion of the open frame structure 131 of the robotic load handling device 130 before the pre-assembled parts are assembled into a modular sub-frame. The pre-assembled part shown in FIGS. 24 and 25 represents a connection or linkage between two connecting blocks 140d on one face of the open frame structure. The jig or fixture 214 comprises a mounting platform 216 and one or more clamps 218 for securing the connecting blocks 140d to the mounting platform in a predefined orientation and separation from each other. In the particular example shown in FIGS. 24 and 25, the connecting blocks 140d correspond to the wheel mounts 139, 141 discussed above with reference to FIG. 22.

One or more guides 220 are used for guiding the connecting elements 184 into the connecting blocks in predefined orientation such that the pre-assembled part has a predefined tolerance in terms of dimension and shape. The guides 220 can comprise one or more datum points that is used for guiding the connecting element into the correct orientation in the connecting block. The default position is for the plurality of fingers within the sockets of the connecting blocks guide the connecting end of the connecting element 184 towards the centre of the socket so that the longitudinal axis of both the connecting element and the socket are concentric. The ability of the radially extending fingers to resiliently deform within the socket enables the orientation of the connecting element 184 to be adjusted relative to the connecting block 140d. The different adjustments possible of the connecting element relative to the connecting block was discussed above with reference to FIG. 7(a to d) and includes (a) angularity; (b) eccentricity; (c) ovality; and (d) combination of angularity and ovality.

Once the connecting blocks and connecting elements have been pre-assembled together in the jig or fixture 214 and if necessary adjusted so that the pre-assembled part falls within a predetermined tolerance of size and/or shape, the connecting elements is secured to their respective connecting blocks in their correct position to prevent further movement when the pre-assembled part is released from the jib or fixture. Whilst the pre-assembled part is clamped to the jig or fixture, adhesive is injected in-situ into the sockets of the connecting blocks via their respective inlets. As discussed above with reference to FIGS. 1 and 2, the inlet having an opening external of the connecting block allows adhesive to be injected into the socket in-situ whilst the pre-assembled part is clamped to the jig or fixture. The amount of adhesive injected into the socket can be determined by presence of adhesive emerging from the vent holes or outlet. The presence of adhesive in the vent holes provides an indication that the adhesive has adequately filled the glue channel defined by the space between the exterior surface of the connecting end of the connecting element and the internal wall of the socket. One or more sets of fingers as discussed above can be used to control the size of the glue channel and thus, the coverage of adhesive on the connecting end of the connecting element within the socket. The cross-sectional dimension of the outlet bore of the vent holes can be varied to prevent excess adhesive escaping from the vent hole, i.e. a portion of the outlet bore is enlarged to capture any excess adhesive overflowing from the socket. Once adhesive is injected into the required inlets of the connecting blocks for securing to their respective connecting elements whilst being clamped in the jig or fixture, the adhesive is allowed to cure before the pre-assembled part is removed from the jig or fixture. The pre-assembled part shown in FIGS. 24 and 25 represent a portion of the frame structure of the robotic load handling device. In the particular example shown in FIGS. 24 and 25, the pre-assembled part represents one face of a modular sub-frame comprising the wheel mounts 139, 141 for mounting a pair of wheels and the cam mechanism 152, i.e. the first modular sub-section 132(a, b, c). This is repeated for the other three faces of the first modular sub-frame making up a total of four faces of a rectangular modular sub-frame as shown in FIG. 17a. Each of the four faces carry a pair wheels of the wheel assembly. To enable each of the four faces carrying a pair of wheels to move independently of one another for changing direction on the grid structure, the pre-assembled parts are held together in a rectangular arrangement by the vertical connecting elements.

The process of pre-assembling the different portions of the frame structure is repeated for the other modular sections of the frame. In the case of the second 133 and third 134 modular sections, the pre-assembled part comprises four connecting blocks that are arranged in a rectangular sub-frame by one or more horizontal connecting elements. Vertically adjacent modular sub-frames are connected together in a vertical stack by one or more vertical connecting elements to form the frame as shown in FIG. 17a. Different jigs or fixtures can be used to pre-assemble the different modular sections of the frame so providing the different functional characteristic of the robotic load handling device.

1-38. (canceled)

39. A connecting block comprising:
i) a socket configured for receiving a connecting end of a connecting element along a first axis, the socket having an internal wall;
ii) a plurality of fingers resiliently biased to extend inwardly in a substantially radial direction from the internal wall of the socket such that when in use the plurality of fingers will conform to the connecting end of the connecting element when the connecting end of the element is received within the socket, the plurality of fingers being spatially distributed around the internal wall of the socket so as to define a guide for guiding the connecting end of the connecting element towards a centre of the socket; and
iii) an inlet including an inlet bore extending along a second axis from an opening external of the connecting block to an opening in the internal wall of the socket, the inlet being configured for injecting adhesive into the socket.

40. The connecting block of claim 39, wherein the plurality of fingers are spaced apart around the internal wall of the socket.

41. The connecting block of claim 39, wherein the plurality of fingers comprise:
a plurality of fins arranged so that each of the plurality of fins at least partially overlap an adjacent fin.

42. The connecting block of claim 39, comprising:
an outlet including an outlet bore extending along a third axis from an opening in the internal wall of the socket to an outlet opening external of the connecting block, the outlet being configured for expelling fluid from the socket.

43. The connecting block of claim 42, wherein the outlet bore comprises:
a first portion having a first cross sectional dimension and a second portion having a second cross sectional dimension, the second cross-sectional dimension being different than the first cross-sectional dimension.

44. The connecting block of claim 39, wherein each of the plurality of fingers comprises:
a first end hingedly coupled to the internal wall of the socket by a flexible joint and a second end, wherein the second end is a free end.

45. The connecting block of claim wherein the second end is tapered.

46. The connecting block of claim 44, wherein the internal wall comprises:
a depression adjacent the first end of each of the plurality of fingers, configured to permit each of the plurality of fingers to rotate about its first end.

47. The connecting block of claim 39, wherein the plurality of fingers are arranged around a circumference of the internal wall of the socket so as to encircle the connecting end of the connecting element when the connecting end of the connecting element is inserted into the socket.

48. The connecting block of claim 39, wherein the plurality of fingers comprises:
a first set of fingers and a second set of fingers, each of the first and second sets of fingers being similarly configured.

49. The connecting block of claim 48, wherein the first set of fingers is spaced apart from the second set of fingers axially along a longitudinal axis of the socket to define a glue channel between the first and second sets of fingers.

50. The connecting block of claim 39, wherein the inlet is disposed between the first and second sets of fingers.

51. The connecting block of claim 39, wherein the plurality of fingers are integrally formed with the connecting block.

52. A connecting block according to claim 39 in combination with a robotic load handling device for lifting and moving one or more containers stackable in a storage and retrieval system, the storage and retrieval system including grid structure including a plurality of grid members including a first set of grid members and a second set of grid members, the second set of grid members being substantially perpendicular to the first set of grid members such that the plurality of grid members are arranged as a grid in a grid pattern for guiding movement of the load handling device on the grid structure, the load handling device comprising a frame supporting:
a) a container lifting mechanism including a container-gripping assembly configured to releasably grip a container, and a lifting drive mechanism configured to raise and lower the container-gripping assembly;
b) a wheel assembly including a first set of wheels configured for engaging with the first set of grid members to guide movement of the load handling device in a first direction and a second set of wheels configured for engaging with the second set of grid members to guide the movement of the load handling device in a second direction, wherein the second direction is transverse to the first direction; and
c) a wheel positioning mechanism configured for selectively lowering or raising the first set of wheels or the second set of wheels into engagement or disengagement with the first set of grid members or the second set of grid members;
wherein the frame comprises:
a plurality of modular sub-frames arranged in a vertical stack, wherein at least one of the plurality of modular sub-frames includes the at least one connecting block, and a connecting element received within the socket of the at least one connecting block.

53. The connecting block and robotic load handling device combination of claim 52, wherein the frame supports:
a receptacle for accommodating a power source, the receptacle having an externally accessible open top end configured for receiving the power source in a substantially vertical direction and including charging receiving elements for electrically coupling with charge providing elements of the power source to provide power to the wheel positioning mechanism and the container lifting mechanism.

54. The connecting block and robotic load handling device combination of claim 52, wherein the at least one of the plurality of modular sub-frames comprises:
at least four connecting blocks, each of the at least four connecting blocks of each modular sub-frame being connected to two other connecting blocks by a plurality of connecting elements to form a rectangular modular sub-frame.

55. The connecting block and robotic load handling device combination of claim 52, wherein each of the plurality of modular sub-frames comprises:
at least four of the connecting blocks, each of the at least four connecting blocks of each modular sub-frame being connected to two other connecting blocks by a plurality of connecting elements to form a rectangular modular sub-frame and wherein the connecting blocks of vertically adjacent modular sub-frames are connected together by a connecting element.

56. The connecting block and robotic load handling device combination of claim 52, wherein the at least one connecting block comprises:
at least a portion of the container lifting mechanism, and/or the wheel assembly, and/or the wheel positioning mechanism, and/or the electrical components.

57. The connecting block and robotic load handling device combination of claim 52, wherein the at least a portion of the container lifting mechanism, and/or the wheel assembly, and/or the wheel positioning mechanism, and/or the electrical components is integrally formed with at least one connecting block.

58. A connecting block and robotic load handling device combination according to claim 52 in combination with an automated storage and retrieval system, the system comprising:
a grid structure including a plurality of grid members including a first set of grid members and a second set of grid members, the second set of grid members being substantially perpendicular to the first set of grid members such that the plurality of grid members are arranged in a grid pattern for guiding the movement of one or more the load handling devices operating on the grid structure; and
the at least one robotic load handling device being configured to be operable on the grid structure.
